(19) United States
(12) Patent Application Publication
(10) Pub. No.: US 2022/0157303 A1
(43) Pub. Date: May 19, 2022

(54) INFORMATION PROCESSING DEVICE AND INFORMATION PROCESSING METHOD

(71) Applicant: Sony Group Corporation, Tokyo (JP)

(72) Inventors: Yuhei TAKI, Tokyo (JP); Hiro IWASE, Tokyo (JP); Kunihito SAWAI, Tokyo (JP)

(73) Assignee: Sony Group Corporation, Tokyo (JP)

(21) Appl. No.: 17/437,837

(22) PCT Filed: Feb. 20, 2020
(86) PCT No.: PCT/JP2020/006668

§ 371 Date: Sep. 10, 2021

(30) Foreign Application Priority Data
Mar. 26, 2019 (JP) 2019-058883

(51) Int. Cl. G10L 15/22

(52) U.S. Cl. CPC G10L 15/22; G10L 2015/225; G10L 2015/223

(57) ABSTRACT

An information processing device according to the application concerned includes an obtaining unit that obtains utterance information containing a request uttered by a user regarding changing the state related to the user, and obtains device condition information indicating the condition of a plurality of devices associated to the request; and includes a deciding unit that, based on the utterance information and the device condition information obtained by the obtaining unit, decides on a target device that, from among a plurality of devices, is to be subjected to the operations corresponding to the request.

### FIELD

The application concerned is related to an information processing device and an information processing method.

### BACKGROUND

Conventionally, there are known technologies for enhancing the user-friendliness of the user who operates devices such as household appliances. For example, a technology has been proposed by which an air conditioner keeps track with the changing requests made by the user regarding the thermal environment.

### CITATION LIST

### Patent Literature

Patent Literature 1: Japanese Patent Application Laid-open No. H2-154940

### SUMMARY

### Technical Problem

According to the conventional technology, the air conditioner representing a device is controlled without using a remote controller.

However, in the conventional technology, it is not always possible to perform flexible operations in response to user requests. For example, in the conventional technology, it is only an air conditioner that is treated as the target device for operations, and it is difficult to implement the conventional technology when there is a plurality of devices. For that reason, it is difficult to perform operations in response to the utterances made by the user with respect to a plurality of devices.

In that regard, in the application concerned, an information processing device and an information processing method are provided that enable performing operations in response to the utterances made by the user with respect to a plurality of devices.

### Solution to Problem

According to the present disclosure, an information processing device includes an obtaining unit that obtains utterance information containing a request uttered by a user regarding changing state related to the user, and device condition information indicating condition of a plurality of devices associated to the request; and a deciding unit that, based on the utterance information and the device condition information obtained by the obtaining unit, decides on a target device that, from among the plurality of devices, is to be operated according to the request.

### BRIEF DESCRIPTION OF DRAWINGS

FIG. 1 is a diagram illustrating an example of the information processing performed according to an embodiment of the application concerned.

FIG. 2 is a diagram illustrating an exemplary configuration of an information processing system according to the embodiment of the application concerned.

FIG. 3 is a diagram illustrating an exemplary configuration of an information processing device according to the embodiment of the application concerned.

FIG. 4 is a diagram illustrating an example of a device information storing unit according to the embodiment of the application concerned.

FIG. 5 is a diagram illustrating an example of an operation history information storing unit according to the embodiment of the application concerned.

FIG. 6 is a diagram illustrating an example of a sensor information storing unit according to the embodiment of the application concerned.

FIG. 7 is a diagram illustrating an example of a threshold value information storing unit according to the embodiment.

FIG. 8 is a diagram illustrating an example of an associated-parameter information storing unit according to the embodiment.

FIG. 9 is a diagram illustrating an example of the operations performed using operation history.

FIG. 10 is a diagram illustrating an example of the operations performed using the operation history.

FIG. 11 is a diagram illustrating an example of the operations performed using the operation history.

FIG. 12 is a diagram illustrating an example of the operations performed using the operation history.

FIG. 13 is a diagram illustrating an example of the operations performed using the operation history.

FIG. 14 is a diagram illustrating another example of the operations performed using the operation history.

FIG. 15 is a diagram illustrating another example of the operations performed using the operation history.

FIG. 16 is a diagram illustrating another example of the operations performed using the operation history.

FIG. 17 is a diagram illustrating another example of the operations performed using the operation history.

FIG. 18 is a diagram illustrating another example of the operations performed using the operation history.

FIG. 19 is a diagram illustrating an example of the operations performed using sensor information.

FIG. 20 is a diagram illustrating another example of the operations performed using the sensor information.

FIG. 21 is a diagram illustrating an example of the operations based on the relationship among a plurality of users.

FIG. 22 is a flowchart for explaining a sequence of a variety of information processing performed according to the embodiment of the application concerned.

FIG. 23 is a hardware configuration diagram illustrating an example of a computer that implements an information processing device or the functions of an information processing device.

### DESCRIPTION OF EMBODIMENTS

An exemplary embodiment of the application concerned is described below in detail with reference to the accompanying drawings. However, an information processing device and an information processing method according to the application concerned are not limited by the embodiment described below. In the embodiment described below, identical constituent elements are referred to by the same reference numerals, and their explanation is not given repeatedly.

The explanation of the application concerned is given in the following order of items.

1. Embodiment
1-1. Overview of information processing according to embodiment of application concerned
1-2. Configuration of information processing system according to embodiment
1-3. Configuration of information processing device according to embodiment
   1-4. Example of operations
   1-4-1. Example of operations performed using operation history
   1-4-2. Regarding each operation phase
   1-4-3. Regarding decision method for deciding on associated parameters
   1-4-4. Example of operations performed using sensor information
   1-4-5. Example of operations based on relationship among a plurality of users
1-5. Sequence of information processing according to the embodiment

2. Other Configuration Examples

3. Hardware Configuration

1. Embodiment

[1-1. Overview of Information Processing According to Embodiment of Application Concerned]

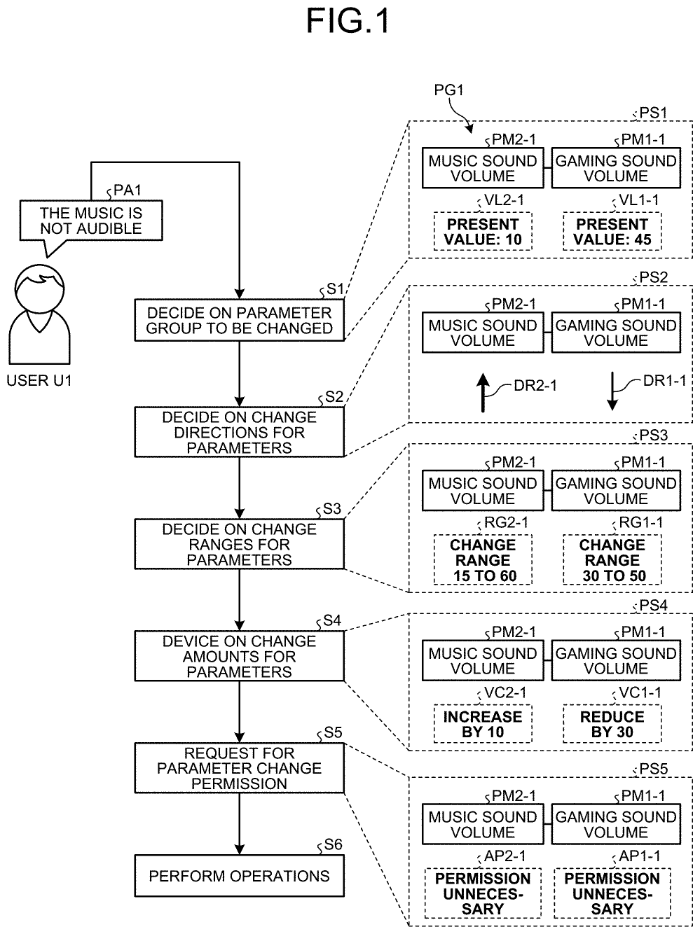

FIG. 1 is a diagram illustrating an example of the information processing performed according to the embodiment of the application concerned. The information processing performed according to the embodiment of the application concerned is performed according to an information processing device 100 illustrated in FIG. 1.

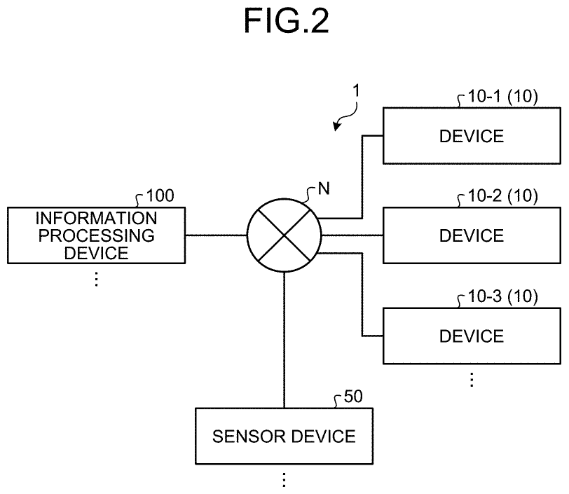

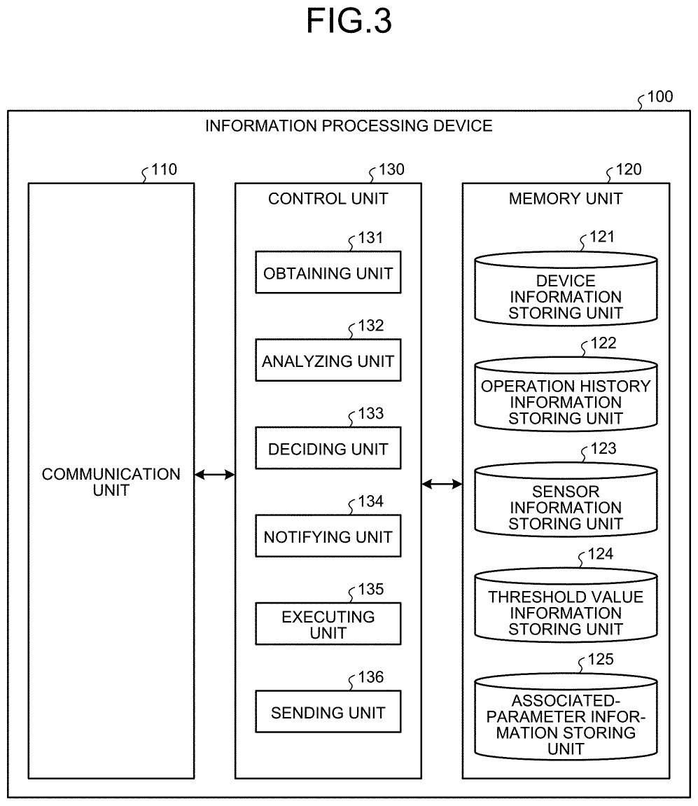

The information processing device 100 is an information processing device for performing the information processing according to the embodiment. The information processing device 100 (refer to FIG. 3) decides on, from among a plurality of devices 10 (refer to FIG. 2), the devices 10 (also called “target devices”) with respect to which the operations are to be performed according to a user request. Although the detailed explanation of the devices 10 is given later, they are, for example, household appliances included in an information processing system 1 (refer to FIG. 2) and capable of communicating with the information processing device 100.

Explained below with reference to FIG. 1 is a case in which the information processing device 100 decides on the target device according to an utterance made by a user U1. In the example illustrated in FIG. 1, the devices 10 represent various types of devices such as household appliances that are kept in a predetermined space such as the living place of the user U1. In the example illustrated in FIG. 1, a plurality of devices 10 such as a personal computer (a device A), a smart speaker (a device B), an air conditioner (a device C), and a smartphone (a device D) can be the target devices.

Firstly, with reference to FIG. 1, the user U1 makes an utterance. For example, around a sensor device 50 (refer to FIG. 2) such as a microphone (a sound sensor), the user U1 makes an utterance PA1 saying “the music is not audible”. Thus, the user U1 makes the utterance PA1 that is not linked to any individual action in the information processing system 1. Then, the sensor device 50 detects voice information of the utterance PA1 indicating “the music is not audible” (also simply called the “utterance PA1”). As a result, the sensor device 50 detects the utterance PA1 indicating “the music is not audible”. Then, the sensor device 50 sends the utterance PA1 to the information processing device 100. As a result, the information processing device 100 obtains the utterance information corresponding to the utterance PA1 (also simply called the “utterance PA1”) from the sensor device 50.

Alternatively, the sensor device 50 can send the voice information of the utterance PA1 to a voice recognition server; obtain character information from the voice recognition server; and then send that character information to the information processing device 100. Still alternatively, if the sensor device 50 itself is equipped with the voice recognition function, the sensor device 50 can send only that information to the information processing device 100 which needs to be sent thereto. Thus, the information processing device 100 can obtain the character information of the voice information (the utterance PA1) from a voice recognition server, or can itself be a voice recognition server.

Meanwhile, the sensor device 50 can send a variety of other information, other than the utterance PA1, to the information processing device 100. Herein, the sensor device 50 sends the detected sensor information to the information processing device 100. For example, the sensor device 50 sends the sensor information corresponding to the point of time of the utterance PA1 to the information processing device 100. Moreover, for example, to the information processing device 100, the sensor device 50 sends, apart from the utterance PA1, a variety of sensor information such as sound information, temperature information, and illumination information detected in the period of time corresponding to the point of time of the utterance PA1 (for example, within one minute from the point of time of the utterance PA1). Meanwhile, the information processing device 100 and the sensor device 50 can be configured in an integrated manner.

The information processing device 100 analyzes the utterance PA1 and identifies its contents. Herein, the information processing device 100 identifies the contents of the utterance PA1 by implementing various conventional technologies. For example, by implementing various conventional technologies, the information processing device 100 analyzes the utterance PA1 made by the user U1 and identifies its contents. Alternatively, for example, by implementing various conventional technologies, the information processing device 100 can parse character information obtained as a result of conversion of the utterance PA1 made by the user U1, and identify the contents. For example, using a natural language processing technology such as morphological analysis, the information processing device 100 can analyze the character information obtained as a result of conversion of the utterance PA1 made by the user U1; extract important keywords from the character information of the utterance PA1 made by the user U1; and identify the contents of the utterance PA1 based on the extracted keywords.

In the example illustrated in FIG. 1, as a result of analyzing the utterance PA1, the information processing device 100 identifies that the utterance PA1 made by the user U1 indicates inaudibility of the sound volume of the music. Based on the analysis result that the utterance PA1 indicates inaudibility of the sound volume of the music, the information processing device 100 identifies that the request made by the user U1 is about changing the state of the sound volume of the music. That is, the information processing device 100 identifies that the utterance PA1 is a request about changing the external environment regarding the sensation of sound of the user U1. Thus, the information processing device 100 identifies that utterance PA1 is a request about changing the external environment in a predetermined space in which the user U1 is present. Hence, the information processing device 100 identifies that the user U1 has requested to change the state of the external environment so that the sounds output by the device 10, which outputs music, become audible.

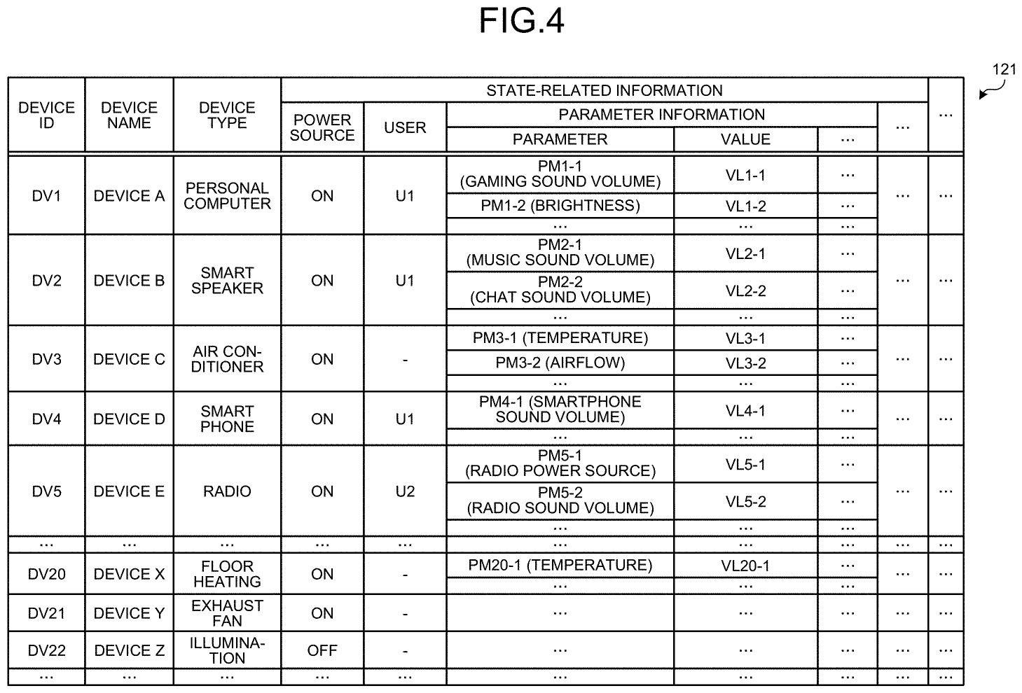

Then, the information processing device 100 decides on the group of parameters to be changed (Step S1). Firstly, the information processing device 100 identifies, as the target devices, the devices having the parameters to be changed. Regarding the user U1, the information processing device 100 identifies the device 10 meant for outputting music. Thus, from among a plurality of devices 10 specified in a device information storing unit 121 (refer to FIG. 4), the information processing device 100 identifies the device 10 that is being used by the user U1 for outputting music. Thus, the information processing device 100 identifies, from among a plurality of devices 10, the device 10 that is associated to the user U1 and that is meant for outputting music. In the example illustrated in FIG. 1, the information processing device 100 decides to treat, as a target device, a device B that has a parameter PM2-1 corresponding to the sound volume of music and that has the user U1 as the associated user.

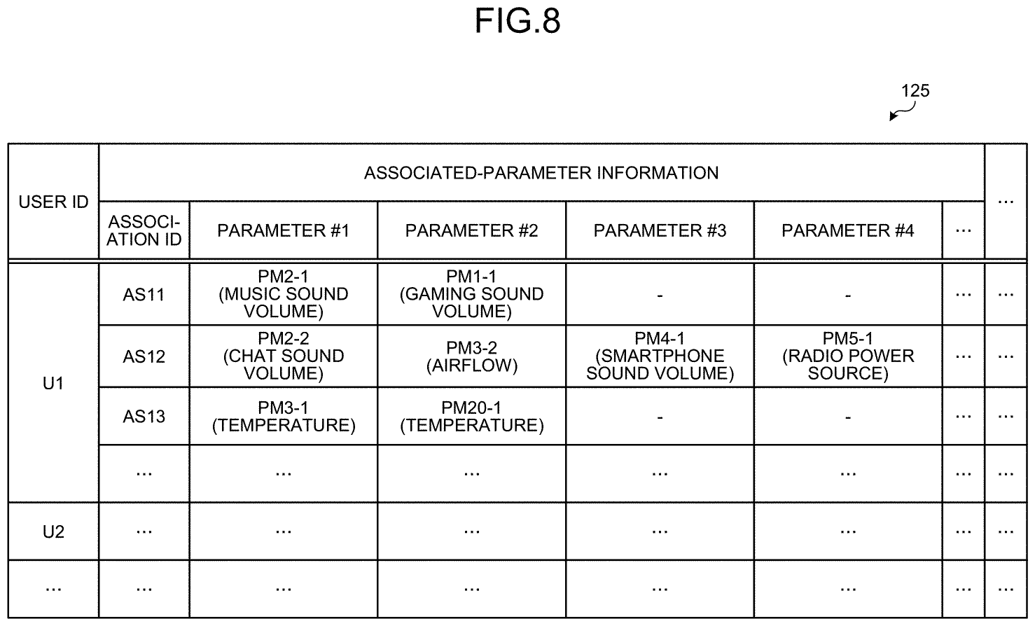

Moreover, the information processing device 100 decides on the target devices based on the information about the associated parameters that are associated to the parameter PM2-1. Herein, the associated parameters represent statistically associated parameters in the history of operations of the concerned user. The detailed explanation about the associated parameters is given later. Thus, based on the associated parameters stored in an associated-parameter information storing unit 125 (refer to FIG. 8), the information processing device 100 identifies the associated parameters of the parameter PM2-1. Herein, the information processing device 100 identifies, as an associated parameter of the parameter PM2-1, a parameter PM1-1 that is about the gaming sound volume and that is associated to the parameter PM2-1. Thus, from among a plurality of devices 10 specified in the device information storing unit 121, the information processing device 100 identifies a device A that represents the device 10 having the parameter PM2-1. Hence, the information processing device 100 decides on the device A as a target device.

In this way, the information processing device 100 decides on the devices B and A as the target devices. Moreover, the information processing device 100 decides on the parameters PM2-1 and PM1-1 as the parameters to be changed (as target parameters). Accordingly, as illustrated in processing PS1, the information processing device 100 decides to treat, as the target parameters, a parameter group PG1 that includes the parameter PM2-1 regarding the music sound volume and the parameter PM2-1 regarding the gaming sound volume. Moreover, the information processing device 100 obtains present-value information indicating that the parameter PM2-1 has a present value VL2-1 to be equal to “10” and that the parameter PM1-1 has a present value VL1-1 to be equal to “45”. Herein, the information processing device 100 can obtain the present-value information either from the device information storing unit 121 or from the target devices.

Then, the information processing device 100 decides on the change directions for the parameters (Step S2). For example, according to the request made by the user U1, the information processing device 100 decides on the change directions for the parameters PM2-1 and PM1-1 representing the target parameters. For example, the information processing device 100 can decide to increase the value of the parameter PM2-1 representing the music sound volume that is desired to be audible by the user U1, and can decide to reduce the value of the parameter PM1-1 that is the other sound parameter. In the example illustrated in FIG. 1, as illustrated in processing PS2, the information processing device 100 decides on an upward direction DR2-1 to be the change direction for the parameter PM2-1, and decides on a downward direction DR1-1 to be the change direction for the parameter PM1-1.

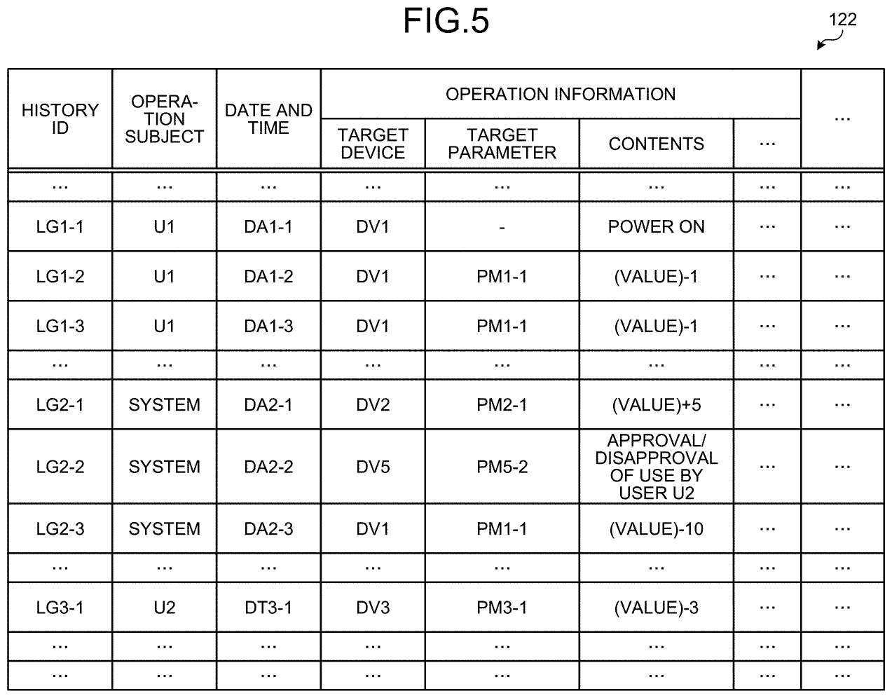

Meanwhile, the information processing device 100 can decide on the change directions for the parameters PM2-1 and PM1-1, which represent target parameters, based on the operation history stored in an operation history information storing unit 122 (refer to FIG. 5). Herein, within a predetermined period of time (for example, 10 seconds or one minute) since an operation of increasing the value of the parameter PM2-1, if an operation of reducing the value of the parameter PM1-1 is performed with a probability equal to or greater than a predetermined level, then the information processing device100 can decide to reduce the parameter PM1-1.

Subsequently, the information processing device 100 decides on the change ranges for the parameters (Step S3). For example, based on the operation history stored in the operation history information storing unit 122, the information processing device 100 decides on the change ranges for the parameters PM2-1 and PM1-1 representing the target parameters. For example, the information processing device 100 decides on, as the change range for the parameter PM2-1, the range between the upper limit and the lower limit of the values of the parameter PM2-1 as specified in the past. Moreover, the information processing device 100 decides on, as the change range for the parameter PM1-1, the range between the upper limit and the lower limit of the values of the parameter PM1-1 as specified in the past. In the example illustrated in FIG. 1, as illustrated in processing PS3, the information processing device 100 decides a range RG2-1 of “15 to 60” as the change range for the parameter PM2-1, and decides a range RG1-1 of “30 to 50” as the change range for the parameter PM2-1.

Then, the information processing device 100 decides on the change amounts for the parameters (Step S4). For example, based on the operation history stored in the operation history information storing unit 122, the information processing device 100 decides on the change amounts for the parameters PM2-1 and PM1-1 representing the target parameters. For example, the information processing device 100 decides on, as the change amount for the parameter PM2-1, the maximum amount that was changed as a result of performing a series of operations within a predetermined period of time (for example, five seconds or 15 seconds) during past changes in the value of the parameter PM2-1. Moreover, the information processing device 100 decides on, as the change amount for the parameter PM1-1, the maximum amount that was changed as a result of performing a series of operations within a predetermined period of time (for example, five seconds or 15 seconds) during past changes in the value of the parameter PM1-1. In the example illustrated in FIG. 1, as illustrated in processing PS4, the information processing device 100 decides on a change amount VC2-1 indicating “increase by 10” as the change amount for the parameter PM2-1, and decides on a change amount VC1-1 indicating “reduce by 30” as the change amount for the parameter PM1-1.

Meanwhile, if the value of a parameter after the application of the change amount falls outside the change range for that parameter, then the information processing device 100 confirms with the user about whether or not to change the value of that parameter by the concerned change amount. In the example illustrated in FIG. 1, after the application of the change amount indicating “reduce by 30”, the value of the parameter PM1-1 becomes equal to “15” that is outside the range RG1-1 of “30 to 50”. Hence, it is confirmed with the user U1 about whether to make that change. For example, the information processing device 100 sends a notification indicating “Is it ok to lower the gaming sound volume beyond the normal range?” to the user terminal of the user U1. In the example illustrated in FIG. 1, the information processing device 100 obtains the permission from the user U1 about changing the value of the parameter PM1-1.

Then, the information processing device 100 requests for parameter change permission (Step S5). Firstly, the information processing device 100 determines whether or not it is required to obtain the parameter change permission. The information processing device 100 determines whether or not the devices 10 having the target parameters include the devices 10 having users other than the user U1 as the associated users. Herein, based on the information stored in the device information storing unit 121, the information processing device 100 determines whether or not the devices 10 having the target parameters include the devices 10 having users other than the user U1 as the associated users.

Thus, the information processing device 100 determines whether or not any device 10 having a user other than the user U1 as the associated user is present among the device B having the parameter PM2-1 and the device A having the parameter PM1-1. Since the device B as well as the device A have the user U1 as the associated user, the information processing device 100 determines that it is not necessary to obtain the parameter change permission. In the example illustrated in FIG. 1, as illustrated in processing PS5, the information processing device 100 decides on permission unnecessary AP2-1 as the parameter change permission for the parameter PM2-1 and decides on permission unnecessary AP1-1 as the parameter change permission for the parameter PM1-1.

Subsequently, the information processing device 100 performs operations with respect to the target devices (Step S6). The information processing device 100 performs operations with respect to the target devices 10 based on the information decided at steps from Step S1 to Step S5. For example, the information processing device 100 performs operations with respect to the device B that is decided to be a target device. The information processing device 100 instructs the device B to increase the value of the parameter PM2-1 representing the music sound volume of the device B. Thus, the information processing device 100 instructs the device B to increase the value of the parameter PM2-1 thereof by “10”. Upon receiving the instruction from the information processing device 100, the device B increases the value of the parameter PM2-1 by “10” and thus raises the sound volume of the output music. As a result, the information processing device 100 increases, in an absolute manner, the sound volume of the music that is output by the device B and thus resolves the state in which the user U1 is not able to hear the music.

Moreover, the information processing device 100 performs operations with respect to the device A that is decided to be a target device. The information processing device 100 instructs the device A to reduce the value of the parameter PM1-1 representing the gaming sound volume therein. Thus, the information processing device 100 instructs the device A to reduce the value of the parameter PM1-1 thereof by “30”. Upon receiving the instruction from the information processing device 100, the device A reduces the value of the parameter PM1-1 by “30” and thus lowers the gaming sound volume. As a result, the information processing device 100 increases, in a relative manner, the sound volume of the music output by the device B and thus resolves the state in which the user U1 is not able to hear the music.

As explained above, based on utterance information that contains a request uttered by the user for changing the user-related state, the information processing device 100 decides on the target devices, which are to be subjected to the operations according to the request, from among a plurality of devices. As a result, the information processing device 100 becomes able to perform operations with respect to a plurality of devices according to a user utterance. Meanwhile, in the example illustrated in FIG. 1, the explanation is given about adjusting the sound volume. However, that is not the only possible case, and there can be various targets for adjustment, such as the temperature, the air flow, and the illumination.

These days, more and more devices are becoming operable by a voice (such as the devices 10), and fundamentally the utterances of the users are often simple comments linked to the individual actions of the system. In such a case, for example, a user makes an utterance such as “set the temperature to 25° ” or “turn off the lights” and operates a single device with a simple command. On the other hand, during a dialogue between persons, the utterances often indicate a plurality of possibilities regarding the actual action, that is, the utterances having ambiguity are exchanged. In such a case, for example, the user makes an utterance such as “the sound of the TV is not audible” or “its little cold”. Regarding such an utterance having ambiguity, it is difficult to perform corresponding operations in a system in which simple comments linked to the individual actions are used.

However, as explained earlier, even with respect to a user utterance having ambiguity, the information processing device 100 refers to device condition information such as the operation history of the user and decides on the target devices and the target parameters corresponding to the user utterance. As a result, the information processing device 100 becomes able to perform operations with respect to a plurality of devices according to a user utterance. That is, the information processing device 100 enables performing operations with respect to the devices 10 in response to utterances having ambiguity. Thus, the information processing device 100 can make the user perform intuitive operations, and can also resolve the issue of performing appropriate operations according to user utterances having ambiguity.

[1-2. Configuration of Information Processing System According to Embodiment]

The following explanation is given about the information processing system 1 illustrated in FIG. 2. As illustrated in FIG. 2, the information processing system 1 includes a plurality of devices 10-1, 10-2, and 10-3; the sensor device 50; and the information processing device 100. In the following explanation, when the devices 10-1 to 10-3 need not be distinguished from each other, they are sometimes referred to as the devices 10. Meanwhile, although three devices 10-1, 10-2, and 10-3 are illustrated in FIG. 2, the information processing system 1 can include more than three devices 10 (for example, 20 or more devices 10, or 100 or more devices 10).

The devices 10, the sensor device 50, and the information processing device 100 are connected to each other in a communicable manner, either using wired communication or using wireless communication, via a predetermined network N. FIG. 2 is a diagram illustrating an exemplary configuration of the information processing system according to the embodiment of the application concerned. Meanwhile, the information processing system 1 illustrated in FIG. 2 can include a plurality of sensor devices 50, a plurality of information processing devices 100, and user terminals used by the users.

Meanwhile, if a user terminal such as a smartphone or a cellular phone of the user is not included in the devices 10, it can be included in the information processing system 1. The user terminal is used in providing a dialogue service in which responses are given to user utterances. The user terminal includes a sound sensor such as a microphone for detecting sounds. For example, the user terminal detects the utterances made around it by the user. For example, the user terminal can be a device that detects surrounding sounds and performs operations according to the detected sounds (i.e., can be a voice assistance terminal). Thus, the user terminal is a terminal device that performs operations in response to user utterances.

The devices 10 are various types of devices used by the user. Moreover, the devices 10 are various types of devices such as the IoT (Internet of Things) devices. The devices 10 are IoT devices such as home appliances. For example, the device 10 can be any type of device as long as it has the communication function, communicates with the information processing device 100, and is capable of performing operations according to operation requests received from the information processing device 100. For example, the device 10 can be what is called a household appliance such as an air conditioner, a television, a radio, a washing machine, or a refrigerator; or can be a product such as an exhaust fan or floor heating installed in a house.

Alternatively, the device 10 can be, for example, an information processing device such as a smartphone, a tablet terminal, a notebook PC (Personal Computer), a desktop PC, a cellular phone, or a PDA (Personal Digital Assistant). Still alternatively, for example, the device 10 can be a wearable device that is worn by the user on the body. For example, the device 10 can be a wrist watch type terminal or a spectacle type terminal. Thus, the device 10 can be any type of device as long as it is capable of performing the operations according to the embodiment.

The sensor device 50 detects a variety of sensor information. The sensor device 50 includes a sound sensor (a microphone) for detecting sounds. For example, the sensor device 50 detects user utterances using the sound sensor. However, the sensor device 50 is not limited to detecting user utterances, and also collects the environmental sounds. Moreover, the sensor device 50 is not limited to include a sound sensor, and also includes various types of sensors.

The sensor device 50 has the function of an imaging unit for the purpose of taking images. Moreover, the sensor device 50 has the function of an image sensor and detects image information. Furthermore, the sensor device 50 functions as an image input unit for receiving images as input. For example, the sensor device 50 can include sensors for detecting a variety of information such as temperature, humidity, ilbrightness, position, acceleration, light, pressure, gyro, and distance. In this way, the sensor device 50 is not limited to be a sound sensor, and can also include various other types of sensors such as an image sensor (a camera) for detecting images; a temperature sensor; a humidity sensor; a position sensor such as a GPS (Global Positioning System) sensor; an acceleration sensor; a light sensor; a pressure sensor; a gyro sensor; and a ranging sensor. Moreover, the sensor device 50 is not limited to include only the abovementioned sensors, and can also include various other types of sensors such as a proximity sensor; and a sensor for obtaining biological information such as body odor, sweating, heartbeat, pulse, and brain waves.

Then, the sensor device 50 can send a variety of sensor information, which is detected by various sensors, to the information processing device 100. Moreover, the sensor device 50 can include a driving mechanism such as an actuator or an encoder-equipped motor. The sensor device 50 can send, to the information processing device 100, sensor information containing information detected in regard to the driving state of the driving mechanism such as an actuator or an encoder-equipped motor. The sensor device 50 can include software modules for performing voice signal processing, voice recognition, utterance semantic analysis, dialogue control, and behavior output.

The explanation given above is only exemplary, and the sensor device 50 is not limited to the explanation given above and can also include various other types of sensors. In the sensor device 50, the detection of a variety of information can be performed using common sensors or can be performed using mutually different sensors. Meanwhile, there can be a plurality of sensor devices 50. Alternatively, the sensor device 50 can be configured in an integrated manner with another device such as the device 10, or the information processing device 100, or a user terminal.

The information processing device 100 is used for providing services regarding the operation of the devices 10 in response to user utterance. The information processing device 100 performs a variety of information processing regarding the operation of the devices 10. The information processing device 100 is an information processing device that, based on utterance information containing requests uttered by the user regarding changes in the user-related condition, decides on the target devices, from among a plurality of devices, with respect to which operations are to be performed according to the requests. The information processing device 100 decides on the target devices based on the device condition information that indicates the condition of a plurality of devices associated to a user request. The device condition information contains a variety of information related to the conditions of devices. Thus, the device condition information contains the operation history of the user with respect to a plurality of devices and contains the sensor information detected by the sensors at the points of time corresponding to the requests.

The information processing device 100 can also include software modules for performing voice signal processing, voice recognition, utterance semantic analysis and dialogue control. Thus, the information processing device 100 can be equipped with the voice recognition function. Alternatively, the information processing device 100 can obtain information from a voice recognition server that provides a voice recognition service. In that case, the voice recognition server can be included in the decision system 1. In the example illustrated in FIG. 1, the information processing device 100 or the voice recognition server implements various conventional technologies to recognize the utterances made by the users and to identify the users who made the utterances.

[1-3. Configuration of Information Processing Device According to Embodiment]

Given below is the explanation of a configuration of the information processing device 100 that represents an example of the information processing device meant for performing the information processing performed according to the embodiment. FIG. 3 is a diagram illustrating an exemplary configuration of the information processing device 100 according to the embodiment of the application concerned.

As illustrated in FIG. 3, the information processing device 100 includes a communication unit 110, a memory unit 120, and a control unit 130. Moreover, the information processing device 100 can also include an input unit (for example, a keyboard or a mouse) for receiving various operations from the administrator of the information processing device 100, and a display unit (for example, a liquid crystal display) that displays a variety of information.

The communication unit 110 is implemented using, for example, an NIC (Network Interface Card). The communication unit 110 is connected to the network N (refer to FIG. 2) in a wired manner or a wireless manner, and sends information to and receives information from other information processing devices such as the devices 10, the sensor device 50, user terminals, and a voice recognition server.

The memory unit 120 is implemented using, for example, a semiconductor memory such as a RAM (Random Access Memory) or a flash memory, or a memory device such as a hard disk or an optical disk. As illustrated in FIG. 3, the memory unit 120 according to the embodiment includes the device information storing unit 121, an operation history information storing unit 122, a sensor information storing unit 123, a threshold value information storing unit 124, and the associated-parameter information storing unit 125.

Moreover, although not illustrated in FIG. 3, the memory unit 120 is used to store user information related to the users. The user information contains a variety of information regarding the user terminals used by the users, and contains a variety of information regarding the attributes of the users. Thus, the user information contains terminal information enabling identification of each user terminal, and contains attribute information such as the age, the gender, the residence, the workplace, and the hobbies of each user. For example, the terminal information is used in identifying the terminals that serve as the notification destinations for sending notifications to the users. For example, the attribute information is used in identifying similar users to each user.

The device information storing unit 121 according to the embodiment is used to store a variety of information regarding the devices. For example, the device information storing unit 121 is capable of communicating with the information processing device 100, and is used to store a variety of information of the devices that can be treated as the target devices. FIG. 4 is a diagram illustrating an example of the device information storing unit according to the embodiment of the application concerned. In the device information storing unit 121 illustrated in FIG. 4, the following items are included: “device ID”, “device name”, “device type”, and “state-related information”.

The item “device ID” represents the identification information for enabling identification of a device. The item “device ID” represents identification information for enabling identification of the device that can be treated as a target device for operations. The item “device name” represents the device name of the concerned device. The item “device name” can be unique information such as the name and the serial number of the concerned device. The item “device type” is used to store the information indicating the type of the concerned device.

The item “state-related information” is used to store a variety of information regarding the state of the concerned device. For example, the item “state-related information” is used to store a variety of information indicating the last obtained state regarding the concerned device. That is, in this case, the “state-related information” is used to store a variety of information indicating the latest state of the concerned device. In the item “state-related information”, the following items are included: “power source”, “user”, and “parameter information”.

The item “power source” is used to store the information regarding the power source of the concerned device. The item “power source” indicates that the power source of the concerned device is either turned ON or turned OFF. The item “user” is used to store the information regarding the user associated to the concerned device. Thus, the item “user” indicates the user of the concerned device. For example, the item “user” indicates the user who turned ON the power source of the concerned device. For example, the user who turned ON the power source of the concerned device is identified according to the functionality of the device 10 itself or according to the sensor information detected by the sensor device 50. Meanwhile, the devices for which the item “user” includes a “- (hyphen)” represent the devices for which there is no associated user or for which the associated user is not clear.

The item “parameter information” is used to store a variety of information regarding the parameters of the concerned device. For example, the “parameter information” is used to store a variety of information indicating the latest state of the parameters of the concerned device. In the item “parameter information”, items such as “parameter” and “value” are included. The item “parameter” represents identification information for enabling identification of the concerned parameter. The item “parameter” is used to store the identification information (a parameter ID) for enabling identification of the concerned parameter. In the example illustrated in FIG. 4, for the purpose of illustration, the information for enabling identification of the concerned parameter contains a parenthesis in which the object corresponding to the concerned parameter is indicated. For example, it is indicated that the parameter “PM1-1” corresponds to the gaming sound volume of the device A that is a personal computer. The item “value” indicates the value of the concerned parameter. The item “value” is used to store the latest value of the concerned parameter. In the example illustrated in FIG. 4, although the item “value” indicates an abstract reference numeral such as “VL1-1”, information indicating a specific value (number) such as “20” or “30” is stored in the item “value”.

In the example illustrated in FIG. 4, it is indicated that the device identified by a device ID “DV1” (i.e., a device DV1) is the device A. Moreover, it is indicated that the device DV1 has the device type of “personal computer”. Furthermore, it is indicated that the device DV1 has the user U1 as the associated user. Moreover, it is indicated that the parameters of the device DV1 include the parameter PM1-1 corresponding to the gaming sound volume and a parameter PM1-2 corresponding to the brightness. The parameter PM1-1 has the value VL1-1, and the parameter PM1-2 has a value VL1-2.

Meanwhile, the device information storing unit 121 is not limited to the explanation given above, and can be used to also store a variety of other information according to the objective.

The operation history information storing unit 122 according to the embodiment is used to store a variety of information regarding the operation history of the devices. For example, the operation history information storing unit 122 is not limited to storing the operations performed by the users. That is, as long as operations are performed with respect to the devices such as the operations performed automatically in the information processing system 1, the operation history of any operation subject can be stored in the operation history information storing unit 122. FIG. 5 is a diagram illustrating an example of the operation history information storing unit according to the embodiment of the application concerned. In the operation history information storing unit 122 illustrated in FIG. 5, the following items are included: “history ID”, “operation subject”, “date and time”, and “operation information”.

The item “history ID” represents identification information for enabling identification of the obtained operation information. The item “operation subject” represents identification information for enabling the subject that performed the concerned operation. For example, the item “operation subject” is used to store identification information for enabling identification of the subject that performed the concerned operation. The item “date and time” indicates the date and time corresponding to the concerned history ID. For example, the item “date and time” indicates the date and time of obtaining the operation information corresponding to the concerned history ID. In the example illustrated in FIG. 5, although the item “date and time” indicates an abstract value such as “DA1-1”, information indicating a specific date and time such as “3/13/2019 22:48:39” can be stored in the item “date and time”.

The item “operation information” represents the obtained operation information. In the item “operation information”, the following items are included: “target device”, “target parameter”, and “contents”. The item “target device” represents the devices with respect to which the operations were performed. The item “target parameter” represents the parameters with respect to which the operations were performed. Meanwhile, if a device has “- (hyphen)” written in the item “target parameter”, it indicates that target for operations is other than the parameters. The item “contents” represents the specific contents of the concerned operation. For example, the item “contents” is used to store the quantity of the changed parameter values in the concerned operation.

In the example illustrated in FIG. 5, the operation history identified by a history ID “LG1-1” (i.e., operation history LG1-1) indicates that the user U1 is the operation subject and that the operation was performed on the date and time DA1-1. Moreover, the operation identified by the operation history LG1-1 indicates that the device DV1 is the target device and that turning ON the power source are the contents. That is, the operation identified by the operation history LG1-1 indicates the operation of turning ON the power source of the device DV1, which represents a personal computer, as performed by the user U1 on the date and time DA1-1.

The operation history identified by a history ID “LG1-2” (i.e., operation history LG1-2) indicates that the user U1 is the operation subject and that the operation was performed on a date and time DA1-2. Moreover, the operation identified by the operation history LG1-2 indicates that the device DV1 is the target device, that the parameter PM1-1 is the target parameter, and that reducing the value by “1” are the contents. That is, the operation identified by the operation history LG1-2 indicates the operation of reducing the value of the parameter PM1-1, which corresponds to the gaming sound volume, of the device DV1 by “1” as performed by the user U1 on the date and time DA1-2.

The operation history identified by a history ID “LG2-1” (i.e., operation history LG2-1) indicates that a system (for example, the information processing system 1) is the operation subject and that the operation was performed on a date and time DA2-1. Moreover, the operation identified by the operation history LG2-1 indicates that the device DV2 is the target device, that the parameter PM2-1 is the target parameter, and that increasing the value by “5” are the contents. That is, the operation identified by the operation history LG2-1 indicates the operation of increasing, by “5”, the value of the parameter PM2-1 corresponding to the music sound volume of the device DV2, which is a smart speaker, as performed by the system on the date and time DA2-1.

Meanwhile, the operation history information storing unit 122 is not limited to storing the information explained above, and can be used to store a variety of other information according to the objective. For example, the operation history information storing unit 122 can be used to store the location corresponding to each history. For example, the operation history information storing unit 122 can be used to store the information indicating the position of the target device on the date and time corresponding to each history ID. For example, the operation history information storing unit 122 can be used to store position information such as the latitude and the longitude of the target device on the date and time corresponding to each history ID.

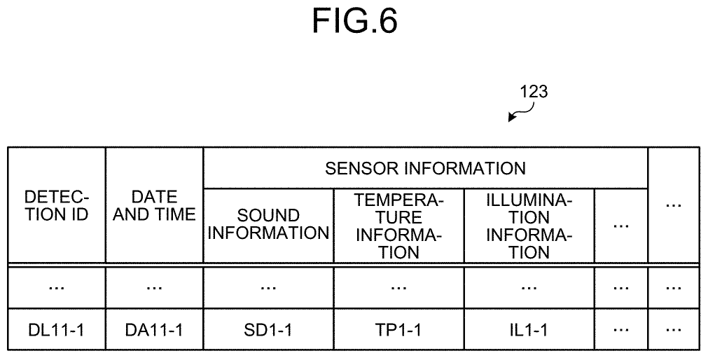

The sensor information storing unit 123 according to the embodiment is used to store a variety of information related to the sensors. FIG. 6 is a diagram illustrating an example of the sensor information storing unit according to the embodiment of the application concerned. For example, the sensor information storing unit 123 is used to store a variety of sensor information detected by the sensor device 50. In the sensor information storing unit 123 illustrated in FIG. 6, the following items are included: “detection ID”, “date and time”, and “sensor information”.

The item “detection ID” represents identification information for enabling identification of the obtained sensor information. The item “date and time” indicates the date and time corresponding to the concerned detection ID. For example, the item “date and time” indicates the date and time of obtaining the sensor information corresponding to the concerned detection ID. In the example illustrated in FIG. 6, although the item “date and time” indicates an abstract value such as “DA11-1”, information indicating a specific date and time such as “3/13/2019 23:18:22” can be stored in the item “date and time”.

The item “sensor information” indicates the detected sensor information. In the item “sensor information”, the following items are included: “sound information”, “temperature information”, and “illumination information”. In the example illustrated in FIG. 6, although the item “sensor information” includes only “sound information”, “temperature information”, and “illumination information”; it can also include items, such as an item “humidity information”, corresponding to a variety of detected sensor information. Thus, the item “sensor information” indicates a variety of information detected regarding the external environment corresponding to the sense of the user.

The item “sound information” indicates the obtained sound information. For example, the item “sound information” is used to store the information indicating the changes in the sound volume. In the example illustrated in FIG. 6, although the item “sound information” indicates an abstract reference numeral such as “SD1-1”, specific sound data can also be used.

The item “temperature information” indicates the obtained temperature information. For example, the item “temperature information” is used to store information indicating the temperature. In the example illustrated in FIG. 6, although the item “temperature information” indicates an abstract reference numeral such as “TP1-1”, a specific numerical value can also be used. The item “illumination information” indicates the obtained illumination information. For example, the item “illumination information” is used to store information indicating the illumination. In the example illustrated in FIG. 6, although the item “illumination information” indicates an abstract reference numeral such as “IL1-1”, a specific numerical value can also be used.

In the example illustrated in FIG. 6, it is indicated that the detection identified by a detection ID “DL11-1” (i.e., detection DL11-1) is the detection corresponding to the date and time DA11-1. In the detection DL11-1, it is indicated that sensor information containing the temperature information TP1-1, the illumination information IL1-1, and the sound information SD1-1 is obtained (detected).

Meanwhile, the sensor information storing unit 123 is not limited to store the information explained above, and can be used to store a variety of other information according to the objective. For example, the sensor information storing unit 123 can be used to store the information enabling identification of the sensor device 50 corresponding to the concerned detection. For example, the sensor information storing unit 123 can be used to store the information indicating the position of the sensor device 50 on the date and time corresponding to the concerned detection ID. For example, the sensor information storing unit 123 can be used to store the position information such as the longitude and the latitude of the sensor device 50 on the date and time corresponding to the concerned detection ID.

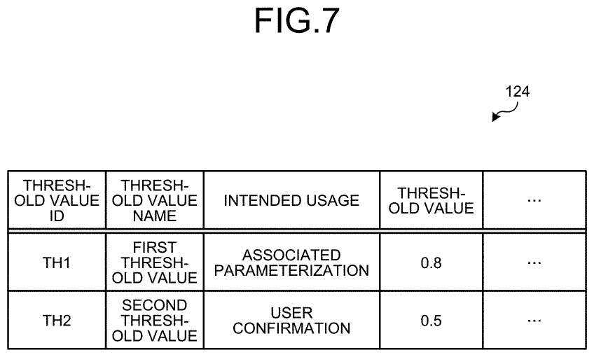

The threshold value information storing unit 124 according to the embodiment is used to store a variety of information regarding a threshold value. The threshold value information storing unit 124 is used to store a variety of information regarding a threshold value used in deciding whether or not the target is to be displayed in a highlighted manner. FIG. 7 is a diagram illustrating an example of the threshold value information storing unit according to the embodiment. In the threshold value information storing unit 124 illustrated in FIG. 7, the following items are included: “threshold value ID”, “threshold value name”, “intended usage”, and “threshold value”.

The item “threshold value ID” represents identification information for enabling identification of the threshold value. The item “threshold value name” indicates the information (naming) such as the threshold value name. The item “intended usage” indicates the end usage of the threshold value. The item “threshold value” indicates the specific value of the threshold value that is identified by the concerned threshold value ID.

In the example illustrated in FIG. 7, it is indicated that the threshold value identified by a threshold value ID “TH1” (i.e., a threshold value TH1) has the threshold name of “first threshold value”. Moreover, it is indicated that the threshold value TH1 has the intended usage of associated parameterization and has the value of “0.8”. Herein, the threshold value TH1 indicates the condition for associated parameterization without requiring user confirmation. For example, it is indicated that, regarding each parameter, if the concerned device is in the ON state at a particular point of time and if the parameter value is variable, then those other parameters which are simultaneously operated with a probability equal to or greater than the threshold value TH1 are automatically treated as associated parameters. For example, it is indicated that, regarding each parameter, if the concerned device is in the ON state at a particular point of time and if the parameter value is variable, then those other parameters which are simultaneously operated with a probability equal to or greater than 80% are automatically treated as associated parameters.

Meanwhile, it is indicated that the threshold value identified by a threshold value ID “TH2” (i.e., a threshold value TH2) has the threshold name of “second threshold value”. Moreover, it is indicated that the threshold value TH2 has the intended usage of user confirmation and has the value of “0.5”. Thus, the threshold value TH2 indicates the condition for performing user confirmation and, based on the user permission, treating parameters as associated parameters. For example, it is indicated that, regarding each parameter, if the concerned device is in the ON state at a particular point of time and if the parameter value is variable, then those other parameters which are simultaneously operated with a probability equal to or greater than the threshold value TH2 but smaller than the threshold value TH1 are confirmed with the user and, if the user gives permission, are treated as associated parameters. For example, it is indicated that, regarding each parameter, if the concerned device is in the ON state at a particular point of time and if the parameter value is variable, then those other parameters which are simultaneously operated with a probability equal to or greater than 50% but smaller than 80% are confirmed with the user and, if the user gives permission, are treated as associated parameters.

Meanwhile, the threshold value information storing unit 124 is not limited to store the information explained above, and can be used to store a variety of other information according to the objective.

The associated-parameter information storing unit 125 is used to store a variety of information regarding the associated parameters. Herein, the associated-parameter information storing unit 125 is used to store a variety of information regarding the associated parameters corresponding to each user. Thus, the associated-parameter information storing unit 125 is used to store a variety of information regarding the associated parameters collected for each user. FIG. 8 is a diagram illustrating an example of the associated-parameter information storing unit according to the embodiment. In the associated-parameter information storing unit 125 illustrated in FIG. 8, items “user ID” and “associated-parameter information” are included. In the item “associated parameter”, items such as “association ID”, “parameter #1”, “parameter #2”, “parameter #3”, and “parameter #4” are included. Meanwhile, in the item “associated parameter”, the number of items for the parameters is equal to the number of associated parameters, and items such as “parameter #5”, “parameter #6”, and so on can be appropriately included.

The item “user ID” represents identification information for enabling identification of the user. Thus, the item “user ID” represents identification information for enabling identification of the user for whom the associated-parameter information is to be collected. For example, the item “user ID” represents identification information for enabling identification of the user. The “associated-parameter information” contains the associated parameters for each user.

The item “association ID” represents information for enabling identification of the association of parameters. The items “parameter #1”, “parameter #2”, “parameter #3”, and “parameter #4” represent the associated parameters.

In the example illustrated in FIG. 8, it is indicated that the user identified by a user ID “U1” (corresponding to the “user U1” illustrated in FIG. 1) has the associations identified by association IDs “AS11”, “AS12”, and “AS13”. The association identified by the association ID “AS11” indicates that, for the user U1, the parameter PM2-1 corresponding to the music sound volume and the parameter PM1-1 corresponding to the gaming sound volume are treated as associated parameters. That is, it is indicated that the parameters PM1-1 and PM2-1 are associated parameters for the user U1.

Meanwhile, the associated-parameter information storing unit 125 is not limited to store the information explained above, and can be used to store a variety of other information according to the objective. Herein, FIG. 8 is a diagram illustrating only an example of storing associated parameters. Alternatively, for example, consider a case in which a particular parameter has another parameter as its associated parameter but that other parameter does not have the particular parameter as its associated parameter. In that regard, a “first-type parameter” can be stored in a corresponding manner to a plurality of “second-type parameters” representing the associated parameters of the “first-type parameter”.

Returning to the explanation with reference to FIG. 3, the control unit 130 is implemented when, for example, a CPU (Central Processing Unit) or an MPU (Micro Processing Unit) executes programs, which are stored in the information processing device 100 (for example, an information processing program such as a decision program according to the application concerned), using a RAM as the work area. Alternatively, the control unit 130 is a controller and is implemented using an integrated circuit such as an ASIC (Application Specific Integrated Circuit) or an FPGA (Field Programmable Gate Array).

As illustrated in FIG. 3, the control unit 130 includes an obtaining unit 131, an analyzing unit 132, a deciding unit 133, a notifying unit 134, an executing unit 135, and a sending unit 136; and implements or executes the functions and the actions of the information processing as explained below. However, the control unit 130 is not limited to have the internal configuration illustrated in FIG. 3, and can alternatively have some other configuration as long as the information processing explained below can be performed. Moreover, the processing units of the control unit 130 are not limited to have the connection relationship illustrated in FIG. 3, and can alternatively have some other connection relationship.

The obtaining unit 131 obtains a variety of information. Herein, the obtaining unit 131 obtains a variety of information from external information processing devices. Thus, the obtaining unit 131 obtains a variety of information from the devices 10. Moreover, the obtaining unit 131 obtains a variety of information from other information processing devices such as the sensor devices 50, user terminals, and voice recognition servers.

Furthermore, the obtaining unit 131 obtains a variety of information from the memory unit 120. Thus, the obtaining unit 131 obtains a variety of information from the device information storing unit 121, the operation history information storing unit 122, the sensor information storing unit 123, the threshold value information storing unit 124, and the associated-parameter information storing unit 125.

Moreover, the obtaining unit 131 obtains a variety of information analyzed by the analyzing unit 132. Furthermore, the obtaining unit 131 obtains a variety of information decided by the deciding unit 133. Moreover, the obtaining unit 131 obtains a variety of information notified by the notifying unit 134. Furthermore, the obtaining unit 131 obtains a variety of information executed by the executing unit 135.

Moreover, the obtaining unit 131 obtains utterance information containing a request uttered by the user regarding the change in the user-related state, and obtains device condition information indicating the condition of a plurality of devices related to the request. Furthermore, the obtaining unit 131 obtains device condition information containing the operation history of the user regarding a plurality of devices. Moreover, the obtaining unit 131 obtains device condition information containing sensor information detected by the sensors at the point of time corresponding to the request.

Furthermore, the obtaining unit 131 obtains utterance information containing a request regarding the change in the external environment corresponding to the senses of the user, and obtains device condition information of a plurality of devices corresponding to the external environment. Moreover, the obtaining unit 131 obtains the utterance information containing a request regarding the change in the external environment of a predetermined space in which the user is present. Furthermore, the obtaining unit 131 obtains utterance information containing identification information that enables identification of the target for change as requested by the user. Moreover, the obtaining unit 131 obtains utterance information containing identification information that indicates a specific device outputting the target. Furthermore, the obtaining unit 131 obtains utterance information containing a request regarding the change in the sound-related state, and obtains device condition information indicating the condition of a plurality of devices related to sounds. Moreover, the obtaining unit 131 obtains information about obtaining permission from the user terminals of other users about the operation of the target devices.

Meanwhile, the obtaining unit 131 can obtain the information regarding each device 10 using an API (Application Programming Interface) corresponding to that device 10. Moreover, the obtaining unit 131 can perform capability confirmation using the API corresponding to each device 10. Furthermore, the obtaining unit 131 can obtain the information regarding the devices 10 using an API (interface) integrated regardless of the devices 10. Moreover, the obtaining unit 131 can obtain the information regarding the devices 10 using various API-related conventional technologies.

For example, regarding the API in Alexa, the following literature has been disclosed.

Alexa Home Skills for Sensors/Contact and Motion API <https://developer.amazon.com/docs/smarthome/build-smart-home-skills-for-sensors.html#message-format>

Moreover, using the API corresponding to each device 10, the obtaining unit 131 can obtain the information indicating the operations possible with respect to that device 10. Furthermore, the obtaining unit 131 can make the sending unit 136 send, and can receive, from each device 10, the information indicating the operations possible with respect to that device 10. Moreover, using the API corresponding to each device 10, the obtaining unit 131 can obtain the information indicating the parameters of the device 10 and their values. Meanwhile, the obtaining unit 131 is not limited to implement only the methods explained above, and can obtain the information regarding the device 10 according to various other methods. For example, the obtaining unit 131 can obtain the information about each device 10 from an external information providing device that provides information indicating the parameters of the device 10 and their values.

In the example illustrated in FIG. 1, the obtaining unit 131 obtains the utterance information corresponding to the utterance PA1 from the sensor device 50. Moreover, the obtaining unit 131 obtains present-value information indicating that the parameter PM2-1 has the present value VL2-1 equal to “10” and that the parameter PM1-1 has the present value VL1-1 equal to “45”. Furthermore, the obtaining unit 131 obtains permission of the user U1 for changing the value of the parameter PM1-1.

The analyzing unit 132 analyzes a variety of information. The analyzing unit 132 analyzes a variety of information based on the information received from external information processing devices and the information stored in the memory unit 120. Moreover, the analyzing unit 132 analyzes a variety of information received from the memory unit 120. Thus, the analyzing unit 132 analyzes a variety of information received from the device information storing unit 121, the operation history information storing unit 122, the sensor information storing unit 123, the threshold value information storing unit 124, and the associated-parameter information storing unit 125. Furthermore, the analyzing unit 132 identifies a variety of information. Moreover, the analyzing unit 132 estimates a variety of information.

Furthermore, the analyzing unit 132 extracts a variety of information. Moreover, the analyzing unit 132 selects a variety of information. Herein, the analyzing unit 132 extracts a variety of information based on the information received from external information processing devices and the information stored in the memory unit 120. Thus, the analyzing unit 132 extracts a variety of information from the device information storing unit 121, the operation history information storing unit 122, the sensor information storing unit 123, the threshold value information storing unit 124, and the associated-parameter information storing unit 125.

Furthermore, the analyzing unit 132 extracts a variety of information based on a variety of information obtained by the obtaining unit 131. Moreover, the analyzing unit 132 extracts a variety of information based on a variety of information decided by the deciding unit 133. Furthermore, the analyzing unit 132 extracts a variety of information based on a variety of information notified by the notifying unit 134. Moreover, the analyzing unit 132 extracts a variety of information based on the information executed by the executing unit 135.

In the example illustrated in FIG. 1, the analyzing unit 132 analyzes the utterance PA1 and identifies its contents. The analyzing unit 132 implements a natural language processing technology such as morphological analysis with respect to the character information obtained as a result of conversion of the utterance PA1 made by the user U1, and extracts important keywords from the character information of the utterance PA1 made by the user U1. Thus, the analyzing unit 132 analyzes the utterance PA1 and identifies its contents about inaudible music. Then, based on the analysis result indicating that the contents of the utterance PA1 indicate inaudible music, the analyzing unit 132 identifies that the request from the user U1 is about changing the state regarding the sound volume of the music. Thus, the analyzing unit 132 identifies that the utterance PA1 is a request for changing the external environment corresponding to the sensation of sound of the user U1. Thus, the analyzing unit 132 identifies that the utterance PA1 is a request for changing the external environment of a predetermined space in which the user U1 is present. The analyzing unit 132 identifies that the user U1 is requesting for a change in the external environment so that the sounds output by the device 10, which outputs music, are audible.

The deciding unit 133 decides on a variety of information. Moreover, the deciding unit 133 identifies a variety of information. Furthermore, the deciding unit 133 determines a variety of information. For example, the deciding unit 133 decides on a variety of information based on the information received from external information processing devices and the information stored in the memory unit 120. Thus, the deciding unit 133 decides on a variety of information based on the information received from other information processing devices such as the devices 10, the sensor devices 50, user terminals, and voice recognition servers. Moreover, the deciding unit 133 decides on a variety of information based on the information stored in the device information storing unit 121, the operation history information storing unit 122, the sensor information storing unit 123, the threshold value information storing unit 124, and the associated-parameter information storing unit 125.

Furthermore, the deciding unit 133 decides on a variety of information based on a variety of information obtained by the obtaining unit 131. Moreover, the deciding unit 133 decides on a variety of information based on a variety of information analyzed by the analyzing unit 132. Furthermore, the deciding unit 133 decides on a variety of information based on a variety of information notified by the notifying unit 134. Moreover, the deciding unit 133 decides on a variety of information based on a variety of information executed by the executing unit 135. Furthermore, the deciding unit 133 updates a variety of information based on the made decision. Moreover, the deciding unit 133 updates a variety of information based on the information obtained by the obtaining unit 131.

Thus, based on the utterance information obtained by the obtaining unit 131 and based on the device condition information, the deciding unit 133 decides on the target device, from among a plurality of devices, with respect to which the operation according to a request is to be performed. The deciding unit 133 decides on the target device based on the operation history in the time slot corresponding to the point of time of the request.

The deciding unit 133 decides on the target device that, from among a plurality of devices, is to be operated for implementing a change in the external environment. Thus, based on the utterance information and the device condition information, the deciding unit 133 decides on the target parameter for change from among a plurality of parameters of the target device.

The deciding unit 133 decides whether to increase or reduce the value of the target parameter. Moreover, the deciding unit 133 decides on the change range for the value of the target parameter. Furthermore, the deciding unit 133 decides on the change amount in the value of the target parameter. Herein, the deciding unit 133 decides on, as the target device, a device other than specific devices from among a plurality of devices. Thus, the deciding unit 133 decides on, as the target device from among a plurality of devices, the target device to be subjected to sound-related output operations.

In the example illustrated in FIG. 1, the deciding unit 133 decides on the group of parameters to be changed. The deciding unit 133 identifies, as the target devices, the devices having the parameters to be changed. The deciding unit 133 identifies the device 10 that outputs music to the user U1. Thus, from among a plurality of devices 10 stored in the device information storing unit 121, the deciding unit 133 identifies the device 10 that outputs music and that is being used by the user U1. Moreover, from among a plurality of devices 10, the deciding unit 133 identifies the device 10 that has the user U1 as the associated user and that outputs music. Thus, the deciding unit 133 decides to treat, as a target device, the device B that has the parameter PM2-1 corresponding to the music sound volume and has the user U1 as the associated user.

Moreover, the deciding unit 133 decides on the target devices based on the information about the associated parameters of the parameter PM2-1. Herein, based on the associated-parameter information stored in the associated-parameter information storing unit 125, the deciding unit 133 identifies the associated parameters of the parameter PM2-1. That is, the deciding unit 133 identifies the parameter PM1-1, which corresponds to the gaming sound volume and which is associated to the parameter PM2-1, as the associated parameter of the parameter PM2-1. Accordingly, the deciding unit 133 identifies the device A, which is the device 10 having the parameter PM2-1, from among a plurality of devices 10 stored in the device information storing unit 121. Then, the deciding unit 133 decides to treat the device A as a target device.

The deciding unit 133 identifies the parameters PM2-1 and PM1-1 as the parameters to be changed (the target parameters). Thus, the deciding unit 133 decides to treat, as the target parameters, the parameter group PG1 that includes the parameter PM2-1 regarding the music sound volume and the parameter PM2-1 regarding the gaming sound volume.

Then, the deciding unit 133 decides on the change directions for the parameters. Herein, according to the request made by the user U1, the deciding unit 133 decides on the change directions for the parameters PM2-1 and PM1-1 representing the target parameters. The deciding unit 133 decides on the upward direction DR2-1 to be the change direction for the parameter PM2-1, and decides on the downward direction DR1-1 to be the change direction for the parameter PM1-1.

Moreover, the deciding unit 133 decides on the change ranges for the parameters. Based on the operation history stored in the operation history information storing unit 122, the deciding unit 133 decides on the change ranges for the parameters PM2-1 and PM1-1 representing the target parameters. Thus, the deciding unit 133 decides on the range RG2-1 of “15 to 60” as the change range for the parameter PM2-1 and decides on the range RG1-1 of “30 to 50” as the change range for the parameter PM2-1.

Furthermore, the deciding unit 133 decides on the change amounts for the parameters. Based on the operation history stored in the operation history information storing unit 122, the deciding unit 133 decides on the change amounts for the parameters PM2-1 and PM1-1 representing the target parameters. The deciding unit 133 decides on the change amount VC2-1 indicating “increase by 10” as the change amount for the parameter PM2-1, and decides on the change amount VC1-1 indicating “reduce by 30” as the change amount for the parameter PM1-1.

Moreover, the deciding unit 133 determines whether it is required to obtain permission for changing the parameters. Furthermore, the deciding unit 133 determines whether or not, from among the devices 10 having the target parameters, there are devices 10 having users other than the user U1 as the respective associated users. Thus, based on the information stored in the device information storing unit 121, the deciding unit 133 decides whether or not, from among the devices 10 having the target parameters, there are devices 10 having users other than the user U1 as the respective associated users.

That is, the deciding unit 133 determines whether or not, from among the device B having the parameter PM2-1 and the device A having the parameter PM1-1, there are devices 10 having users other than the user U1 as the associated respective users. Herein, since the device A as well as the device B has the user U1 as the associated user, the deciding unit 133 determines that there is no need to obtain permission for changing the parameters. Thus, the deciding unit 133 decides on the permission unnecessary AP2-1 as the parameter change permission for the parameter PM2-1 and decides on the permission unnecessary AP1-1 as the parameter change permission for the parameter PM1-1.

The notifying unit 134 notifies a variety of information. For example, the notifying unit 134 notifies a variety of information based on the information received from external information processing devices and the information stored in the memory unit 120. Thus, the notifying unit 134 notifies a variety of information based on the information received from other information processing devices such as the devices 10, the sensor devices 50, user terminals, and voice recognition servers. Moreover, the notifying unit 134 notifies a variety of information based on the information stored in the device information storing unit 121, the operation history information storing unit 122, the sensor information storing unit 123, the threshold value information storing unit 124, and the associated-parameter information storing unit 125.

Furthermore, the notifying unit 134 notifies a variety of information based on a variety of information obtained by the obtaining unit 131. Moreover, the notifying unit 134 notifies a variety of information based on a variety of information analyzed by the analyzing unit 132. Furthermore, the notifying unit 134 notifies a variety of information based on a variety of information decided by the deciding unit 133. Moreover, the notifying unit 134 notifies a variety of information based on a variety of information executed by the executing unit 135. Herein, the notifying unit 134 notifies a variety of information to the devices 10 or user terminals according to the instruction given by the executing unit 135.

When the target devices decided by the deciding unit 133 have a predetermined relationship with a plurality of users including the user, the notifying unit 134 notifies the other users other than the user about notification information regarding the operation of the target devices. Thus, the notifying unit 134 notifies the other users of the target devices about the notification information. Herein, the notifying unit 134 notifies the other users, who are affected by the operation of the target devices, about the notification information. The notifying unit 134 notifies the other users about the information confirming whether or not the target devices can be operated.

Meanwhile, if the value of a parameter after the application of the change amount falls outside the change range for that parameter, then the notifying unit 134 confirms with the user about whether or not to change the value of that parameter by the concerned change amount. In the example illustrated in FIG. 1, after the application of the change amount VC1-1 indicating “reduce by 30”, the value of the parameter PM1-1 becomes “15” that is outside the range RG1-1 of “30 to 50”. Hence, it is confirmed with the user U1 about whether to make the change. For example, the notifying unit 134 sends a notification indicating “Is it ok to lower the gaming sound volume beyond the normal range?” to the user terminal of the user U1.

The executing unit 135 executes a variety of information. The executing unit 135 executes a variety of information based on the information received from external information processing devices and the information stored in the memory unit 120. Thus, the executing unit 135 executes a variety of information based on the information received from other information processing devices such as the devices 10, the sensor devices 50, user terminals, and voice recognition servers. Moreover, the executing unit 135 executes a variety of information based on the information stored in the device information storing unit 121, the operation history information storing unit 122, the sensor information storing unit 123, the threshold value information storing unit 124, and the associated-parameter information storing unit 125.

Furthermore, the executing unit 135 executes a variety of information based on a variety of information obtained by the obtaining unit 131. Moreover, the executing unit 135 executes a variety of information based on a variety of information analyzed by the analyzing unit 132. Furthermore, the executing unit 135 executes a variety of information based on a variety of information decided by the deciding unit 133. Moreover, the executing unit 135 executes a variety of information based on a variety of information notified by the notifying unit 134.

The executing unit 135 performs operations with respect to the target devices that are decided by the deciding unit 133. Thus, the executing unit 135 performs operations with respect to the target parameters that are decided by the deciding unit 133. Herein, the executing unit 135 performs the operation of increasing the values of the target parameters. Moreover, the executing unit 135 performs the operation of reducing the values of the target parameters. The executing unit 135 performs operations based on the change ranges for the values of the target parameters as decided by the deciding unit 133. Moreover, the executing unit 135 performs operations based on the values of the target parameters as decided by the deciding unit 133.

The executing unit 135 makes the sending unit 136 send control information indicating the operations with respect to the target devices. The executing unit 135 makes the sending unit 136 send control information, which is about performing operations to change the target parameters, to the device 10. The executing unit 135 makes the sending unit 136 send control information indicating the operations with respect to the target devices. The executing unit 135 makes the sending unit 136 send control information, which is about performing operations to change the target parameters, to the device 10.

Herein, the executing unit 135 generates the control information to be used in controlling the devices 10. Moreover, the executing unit 135 generates instruction information to be used in instructing the devices 10 to perform predetermined operations. Furthermore, the executing unit 135 generates instruction information to be used in instructing the devices 10 about changing the parameters. The executing unit 135 generates the control information to be used in controlling the devices 10. Moreover, the executing unit 135 implements various conventional technologies related to the control of electronic devices and IoT devices, and generates control information to be used in controlling the devices 10 and generates instruction information to be used in instructing the devices 10 to perform predetermined operations.

Meanwhile, the explanation given above is only exemplary; and the executing unit 135 can implement any method to perform operations with respect to the target devices 10, as long as the devices 10 can be made to perform the operations. Thus, the executing unit 135 can perform operations with respect to the devices 10 using APIs corresponding to the devices 10. Thus, using APIs corresponding to the devices 10, the executing unit 135 can perform the operation of changing the values of the parameters in the devices 10.

Meanwhile, when the other users give permission to perform operations with respect to the target devices, the executing unit 135 performs operations with respect to the target devices. Thus, when information indicating permission for performing the operations with respect to the target devices is obtained from the user terminals of the other users, the executing unit 135 performs operations with respect to the target devices.

In the example illustrated in FIG. 1, the executing unit 135 performs operations with respect to the target devices. Thus, the executing unit 135 performs operations with respect to the device B that is decided to be a target device. The executing unit 135 instructs the device B to increase the value of the parameter PM2-1 representing the music sound volume of the device B. Herein, the executing unit 135 instructs the device B to increase the value of the parameter PM2-1 thereof by “10”. Moreover, the executing unit 135 performs operations with respect to the device A that is decided to be a target device. The executing unit 135 instructs the device A to reduce the value of the parameter PM1-1 representing the gaming sound volume of the device A. Herein, the executing unit 135 instructs the device A to reduce the value of the parameter PM1-1 thereof by “30”.

The sending unit 136 provides a variety of information to external information processing devices. That is, the sending unit 136 sends a variety of information to external information processing devices. For example, the sending unit 136 sends a variety of information to other information processing devices such as the devices 10, the sensor devices 50, user terminals, and voice recognition servers. Moreover, the sending unit 136 provides the information stored in the memory unit 120. That is, the sending unit 136 sends the information stored in the memory unit 120.

Furthermore, the sending unit 136 provides a variety of information based on the information received from other information processing devices such as the devices 10, the sensor devices 50, user terminals, and voice recognition servers. Moreover, the sending unit 136 provides a variety of information based on the information stored in the memory unit 120. Thus, the sending unit 136 provides a variety of information based on the information stored in the device information storing unit 121, the operation history information storing unit 122, the sensor information storing unit 123, the threshold value information storing unit 124, and the associated-parameter information storing unit 125.

Furthermore, the sending unit 136 sends a variety of information based on a variety of information obtained by the obtaining unit 131. Moreover, the sending unit 136 sends a variety of information based on a variety of information analyzed by the analyzing unit 132. Furthermore, the sending unit 136 sends a variety of information based on a variety of information decided by the deciding unit 133. Moreover, the sensing unit 136 sends a variety of information based on a variety of information executed by the executing unit 135. Herein, the sending unit 136 sends a variety of information to the devices 10 according to the instruction received from the executing unit 135. Thus, according to the instruction received from the executing unit 135, the sending unit 136 sends instruction information to the devices 10 as an instruction to perform predetermined operations. According to the instruction received from the executing unit 135, the sending unit 136 sends instruction information to the devices 10 as an instruction to change the values of the parameters. Moreover, according to the instruction received from the executing unit 135, the sending unit 136 sends control information, which is meant for controlling the devices 10, to the devices 10.

In the example illustrated in FIG. 1, the sending unit 136 sends, to the device B, instruction information as an instruction to increase the value of the parameter PM2-1 representing the music sound volume of the device B. Herein, the sending unit 136 sends, to the device B, instruction information as an instruction to increase the value of the parameter PM2-1 of the device B by “10”. Moreover, the sending unit 136 sends, to the device A, instruction information as an instruction to reduce the value of the parameter PM1-1 representing the gaming sound volume of the device A. Herein, the sending unit 136 sends, to the device A, instruction information as an instruction to reduce the value of the parameter PM1-1 of the device A by “30”.

[1-4. Example of Operations]

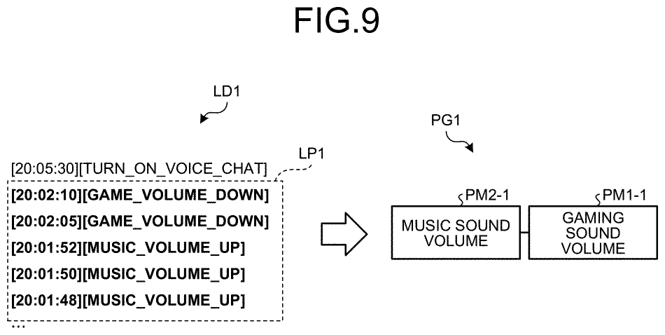

Explained below with reference to FIGS. 9 to 21 are the specific examples of various operations. As illustrated in FIGS. 9 to 21, the information processing device 100 uses a variety of information and performs operations such as deciding on the target devices and the target parameters and changing the target parameters. Meanwhile, in the explanation given with reference to FIGS. 9 to 21, the points that are already explained with reference to FIG. 1 are not explained again.

[1-4-1. Example of Operations Performed using Operation History]

For example, the information processing device 100 can take various decisions using the operation history of the user. For example, the information processing device 100 can refer to the history of parameter operations based on the physical operations such as remote control operations performed by the user. The operation history attributed to the physical operations includes a variety of information such as the maximum values and the minimum values of the parameters used by the user and the period of time in which the operations were performed. The operation history attributed to the remote control operations includes a variety of information such as the maximum values and the minimum values of the parameter change amounts set by the user and the period of time in which the operations were performed. Meanwhile, the operation history is not limited to the examples given above, and can include a variety of other information.

For example, the information processing device 100 can refer to the history of parameter operations based on the voice operations performed by the user. For example, the operation history based on the voice operations includes a variety of information such as the maximum values and the minimum values of the parameters used by the user and the period of time in which the operations were performed. Moreover, the operation history based on the voice operations includes a variety of information such as the maximum values and the minimum values of the parameter change amounts set by the user and the period of time in which the operations were performed.

Subsequently, if the user utters “raise the sound volume”; then, based on the past operation history, the information processing device 100 increases the value of that parameter by the average change amount within the range between the maximum value and the minimum value for that parameter in the past. Moreover, if the user utters “the music is not audible”; then, based on the past operation history, when the past maximum value of that parameter is exceeded, the information processing device 100 increases the value of the parameter for the music sound volume. Furthermore, if the user utters “the music is not audible”; then, based on the past operation history, when the past maximum value of that parameter is exceeded, the information processing device 100 reduces the values of the parameters other than the music sound volume.

Meanwhile, when the information is present in individual time slots, the information processing device 100 can use the information according to the individual time slots. For example, the information processing device 100 can decide on the target devices based on the operation history in the time slot corresponding to the point of time of the request. The information processing device 100 can decide on the target devices based on the operation history in the time slot corresponding to the point of time at which the user made the utterance including the request. For example, the information processing device 100 can decide on the target devices based on the operation history of a first time slot (for example, the morning time slot) corresponding to the point of time at which the user made the utterance including the request. If the parameters of the device A and the parameters of the device B satisfy the conditions for associated parameters in the first time slot; when the user makes an utterance of a request regarding a parameter of the device A in the first time slot, the information processing device 100 can decide on the devices A and B as the target devices.

If the parameters of the device A and the parameters of the device B do not satisfy the conditions for associated parameters in a second time slot (for example, the night time slot) that is different than the first time slot; when the user makes an utterance of a request regarding a parameter of the device A in the second time slot, the information processing device 100 need not decide on the device B as a target device. However, on the other hand, if the parameters of the device A and the parameters of a device D satisfy the conditions for associated parameters in the second time slot; when the user makes an utterance of a request regarding a parameter of the device A in the first time slot, the information processing device 100 can decide on the devices A and D as the target devices.

Meanwhile, using the history of an utterance such as “a little more” or “more” made by the user regarding the change amount, the information processing device 100 can decide on the change amount for the parameters. For example, using the history of an utterance such as “a little more” or “more” made by the user with respect to the values of the parameters that were automatically changed by the information processing system 1, the information processing device 100 can decide on the change amount for the parameters. For example, when the user makes an utterance such as “a little more” or “more” with respect to the automatically-changed values of the parameters, the information processing device 100 can decide on increasing the change amount for the parameters.

Meanwhile, the explanation given above is only exemplary, and the information processing device 100 can decide on a variety of other information using the operation history. Explained below with reference to FIGS. 9 to 18 are examples of the operations performed using the operation history. In FIGS. 9 to 18 are illustrated the operations meant for deciding on a variety of information using the operation history. The example illustrated in FIGS. 9 to 13 is about the operations for changing the music sound volume and the gaming sound volume in an identical manner to FIG. 1. The information processing device 100 performs operations according to the sequence illustrated in FIGS. 9 to 13. In the example illustrated in FIGS. 9 to 13, in an identical manner to FIG. 1, the user makes an utterance saying “the music is not audible”.

Firstly, the explanation is given about the operations illustrated in FIG. 9. FIG. 9 is a diagram illustrating an example of the operations performed using the operation history. More particularly, FIG. 9 is a diagram illustrating an example of the operations for detecting the target parameters using the operation history.

As illustrated in FIG. 9, the information processing device 100 refers to the operation history and identifies the target parameters to be changed. Thus, the information processing device 100 refers to the operation history and decides on the target parameters to be changed. The information processing device 100 refers to the past operation history (a log) such as log information LD1, and identifies the parameters that need to be changed accompanying a change in an arbitrary parameter. More particularly, the information processing device 100 decides on the target parameters by referring to the information indicating that the music sound volume and the gaming sound volume in a log portion LP1 in the log information LD1 were changed in the same period of time (also simply called “simultaneously changed”) within a predetermined range (for example, 30 seconds or two minutes). Based on the operation history such as the log information LD1, the information processing device 100 collects information indicating that, regardless of the time slot, the music sound volume and the gaming sound volume are simultaneously operated at the probability of 80% or more. As a result, the information processing device 100 decides to treat the parameter group PG1, which includes the parameter PM2-1 regarding the music sound volume and the parameter PM2-1 regarding the gaming sound volume, as the target parameters satisfying the condition of the first threshold value “0.8” that is stored in the threshold value information storing unit 124 (refer to FIG. 7).

Moreover, as the parameters satisfying the condition of the first threshold value “0.8” that is stored in the threshold value information storing unit 124 (refer to FIG. 7), the information processing device 100 can store the parameters PM2-1 and PM1-1 as the associated parameters in the associated-parameter information storing unit 125 (refer to FIG. 8).

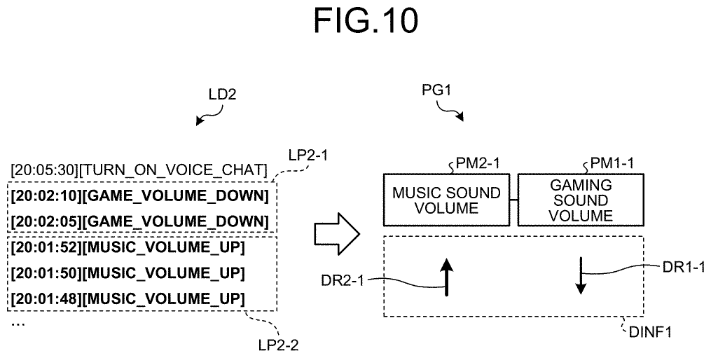

The following explanation is given about the operations illustrated in FIG. 10. FIG. 10 is an example of the operations performed using the operation history. More particularly, FIG. 10 is a diagram illustrating an example of the operations performed to decide on the change directions for the target parameters using the operation history.

As illustrated in FIG. 10, the information processing device 100 refers to the operation history and decides on the change directions for the associated parameters. The information processing device 100 refers to the operation history and decides on the change directions for the target parameters. The information processing device 100 identifies, from the past operation history (a log) such as log information LD2, the change directions for the associated parameters at the time when an arbitrary parameter is changed. More particularly, the information processing device 100 refers to the information, such a log portion LP2 in the log information LD2, indicating that the gaming sound volume is reduced along with increasing the music sound volume, and decides on information DINF1 regarding the change directions for the target parameters. In the example illustrated in FIG. 10, the information processing device 100 decides on the upward direction DR2-1 to be the change direction for the parameter PM2-1 corresponding to the music sound volume, and decides on the downward direction DR1-1 to be the change direction for the parameter PM1-1 corresponding to the gaming sound volume.

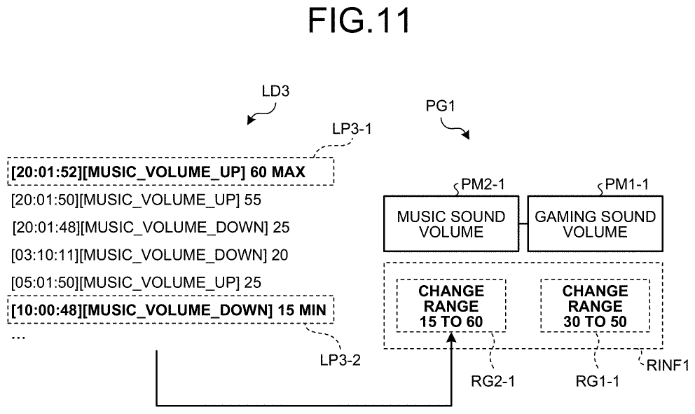

The following explanation is given about the operations illustrated in FIG. 11. FIG. 11 is a diagram illustrating an example of the operations performed using the operation history. More particularly, FIG. 11 is a diagram illustrating an example of the operations for deciding on the change range for the target parameters using the operation history.

As illustrated in FIG. 11, the information processing device 100 refers to the operation history and decides on the change ranges for the associated parameters. The information processing device 100 refers to the operation history and decides on the change ranges for the target parameters. The information processing device 100 refers to the past operation history (a log) such as log information LD3, identifies the region in which the parameters were changed in a certain period of time in the past, and performs parameter adjustment within that range. If a change falls outside the range used in the past, then the information processing device 100 confirms with the user by asking “Do you want to keep on increasing?”.

More particularly, the information processing device 100 refers to the operation history such as the log information LD3, and decides on information RINF1 indicating the change ranges for the target parameters. Thus, the information processing device 100 refers to the information about the maximum value “60” of the music sound volume indicated in a log portion LP3-1 in the log information LD3 and about the minimum value “15” of the music sound volume indicated in the log portion LP3-2, and decides on the range RG2-1 indicating “15 to 60” as the change range for the parameter PM2-1 corresponding to the music sound volume. In an identical manner, the information processing device 100 decides on the range RG1-1 indicating “30 to 50” as the change range for the parameters PM2-1 corresponding to the gaming sound volume.

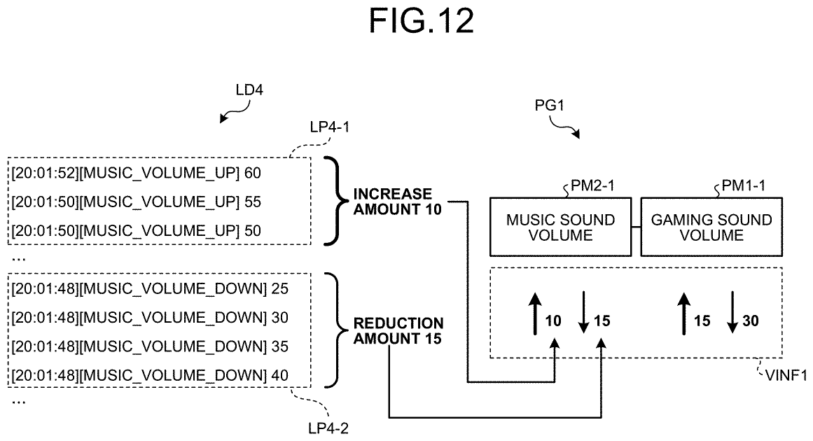

The following explanation is given about the operations illustrated in FIG. 12. FIG. 12 is a diagram illustrating an example of the operations performed using the operation history. More particularly, FIG. 12 is a diagram illustrating an example of the operations for deciding on the change amounts for the target parameters using the operation history.

As illustrated in FIG. 12, the information processing device 100 refers to the operation history and decides on the change amounts for the associated parameters. The information processing device 100 refers to the operation history and decides on the change amounts for the target parameters. The information processing device 100 refers to the past operation history (a log) such as log information LD4; identifies, from the past operation log, the change amounts (within a predetermined period of time) that were applied at the time of changing the parameters; and decides on the adjustment amounts for the associated parameters.

More particularly, the information processing device 100 refers to the operation history such as the log information LD4, and decides on information VINF1 regarding the change amounts for the target parameters. Thus, based on a series of operations illustrated in a log portion LP4-1 in the log information LD4, the information processing device 100 decides on an increase amount of “10” for the parameter PM2-1 corresponding to the music sound volume. Moreover, based on a series of operations illustrated in a log portion LP4-2 in the log information LD4, the information processing device 100 decides on a reduction amount of “15” for the parameter PM2-1 corresponding to the music sound volume. In an identical manner, based on a series of operations illustrated in the log portion LP4-1 in the log information LD4, the information processing device 100 decides on an increase amount of “15” and a reduction amount of “30” for the parameter PM2-1 corresponding to the gaming sound volume.

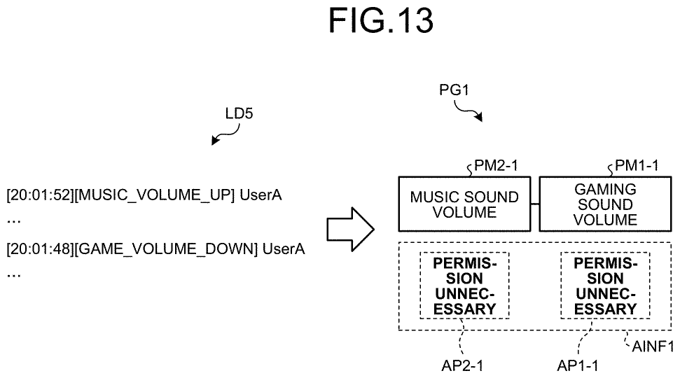

The following explanation is given about the operations illustrated in FIG. 13. FIG. 13 is a diagram illustrating an example of the operations performed using the operation history. More particularly, FIG. 13 is a diagram illustrating an example of the operations for deciding on whether to obtain permission for changing the target parameters using the operation history. With reference to FIG. 13, “UesrA” corresponds to the user U1 illustrated in FIG. 1.

As illustrated in FIG. 13, the information processing device 100 refers to the operation history such as log information LD5 and, based on the associated users of the devices 10 having the target parameters, determines whether or not it is required to obtain permission for changing the parameters. The information processing device 100 refers to the operation history and identifies the associated users of the devices 10 having the target parameters. As illustrated in the log information LD5, since it is the user UesrA (the user U1) who changed the parameter PM2-1 corresponding to the music sound volume, the information processing device 100 determines that there is no need to obtain permission for changing the parameter PM2-1. Moreover, as illustrated in the log information LD5, since it is the user UesrA (the user U1) who changed the parameter PM1-1 corresponding to the gaming sound volume, the information processing device 100 determines that there is no need to obtain permission for changing the parameter PM1-1. In this way, using the operation history such as the log information LD5, the information processing device 100 decides on information AINF1 regarding the permission for changing the target parameters. More particularly, the information processing device 100 decides on the permission unnecessary AP2-1 to be the parameter change permission for the parameter PM2-1 and decides on the permission unnecessary AP1-1 to be the parameter change permission for the parameter PM1-1.

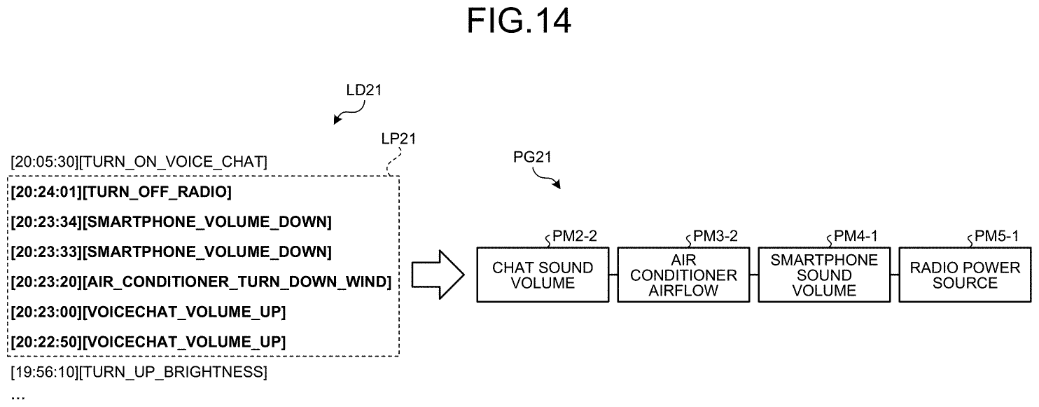

In FIGS. 14 to 18 are illustrated other examples of the operations for deciding on a variety of information using the operation history. The examples illustrated in FIGS. 14 to 18 are about the operations for changing three or more parameters. The information processing device 100 performs operations according to the sequence illustrated in FIGS. 14 to 18. In the example illustrated in FIGS. 14 to 18, the user U1 makes an utterance saying “The chat is not audible” at 21:00. In the example illustrated in FIGS. 14 to 18, the parameters that are simultaneously operated during a predetermined time slot (20:00 to 24:00) are treated as the target parameters.

Firstly, the explanation is given about the operations illustrated in FIG. 14. FIG. 14 is a diagram illustrating another example of the operations performed using the operation history. More particularly, FIG. 14 is a diagram illustrating an example of the operations for deciding the target parameters using the operation history.

As illustrated in FIG. 14, the information processing device 100 refers to the operation history and identifies the target parameters to be changed. The information processing device 100 refers to the operation history and decides the target parameters to be changed. The information processing device 100 refers to the past operation history (a log) such as log information LD21, and identifies the parameters that need to be changed accompanying a change in an arbitrary parameter. More particularly, the information processing device 100 decides on the target parameters by referring to the information such as a log portion LP21 in the log information LD21 indicating that, during the period of time (the time slot) from 20:00 to 24:00, the voice chat sound volume (also simply called “chat sound volume”), the air conditioner airflow, the smartphone sound volume, and the radio power source were simultaneously changed. Based on the operation history such as the log information LD21, the information processing device 100 collects information indicating that, in the time slot from 20:00 to 24:00, the probability of simultaneous operation of the chat sound volume, the air conditioner airflow, the smartphone sound volume, and the radio power source is 70% or more. As a result, the information processing device 100 confirms with the user about whether those parameters can be treated as associated parameters, which satisfy a condition of being equal to or greater than a second threshold value “0.5” but being smaller than the first threshold value “0.8” as stored in the threshold value information storing unit 124 (refer to FIG. 7). In the examples illustrated in FIGS. 14 to 18, the information processing device 100 obtains approval of the user U1 to treat the following parameters as associated parameters: a parameter PM2-2 corresponding to the chat sound volume; a parameter PM3-2 corresponding to the air conditioner airflow; a parameter PM4-1 corresponding to the smartphone sound volume; and a parameter PM5-1 corresponding to the radio power source. With that, the information processing device 100 decides, as the target parameters, a parameter group PG21 that includes the parameter PM2-2 corresponding to the chat sound volume; the parameter PM3-2 corresponding to the air conditioner airflow; the parameter PM4-1 corresponding to the smartphone sound volume; and the parameter PM5-1 corresponding to the radio power source.

Then, the information processing device 100 can store the parameters PM2-2, PM3-2, PM4-1, and PM5-1, which have been approved by the user U1, as associated parameters in the associated-parameter information storing unit 125 (refer to FIG. 8).

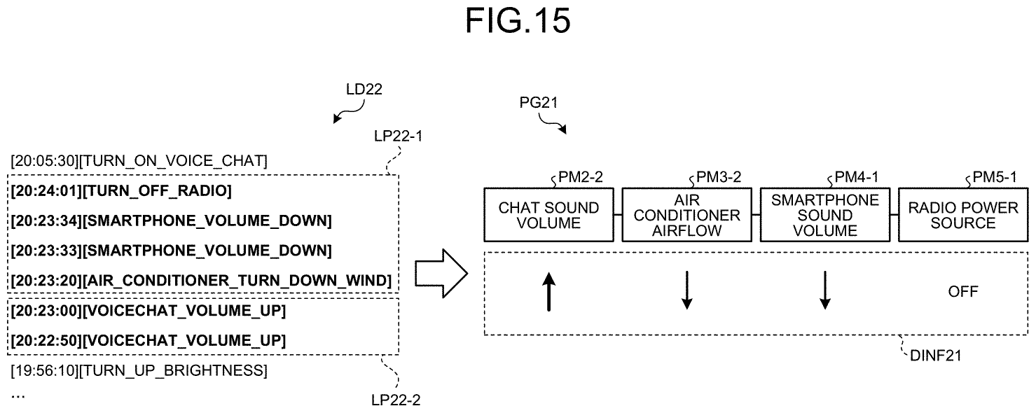

The following explanation is given about the operations illustrated in FIG. 15. FIG. 15 is a diagram illustrating another example of the operations performed using the operation history. More particularly, FIG. 15 is a diagram illustrating another example of the operations for deciding the change directions for the target parameters using the operation history.

As illustrated in FIG. 15, the information processing device 100 refers to the operation history and decides on the change directions for the associated parameters. The information processing device 100 refers to the operation history and decides on the change directions for the target parameters. The information processing device 100 refers to the past operation history (a log) such as log information LD22, and identifies the change directions for the associated parameters accompanying a change in an arbitrary parameter. More particularly, the information processing device 100 refers to the information such as log portions LP22-1 and LP22-2 in the log information LD22 indicating that the air conditioner airflow is reduced, the smartphone sound volume is reduced, the radio power source is turned OFF, and the chat sound volume is increased; and decides on information DINF2 about the change directions for the target parameters.

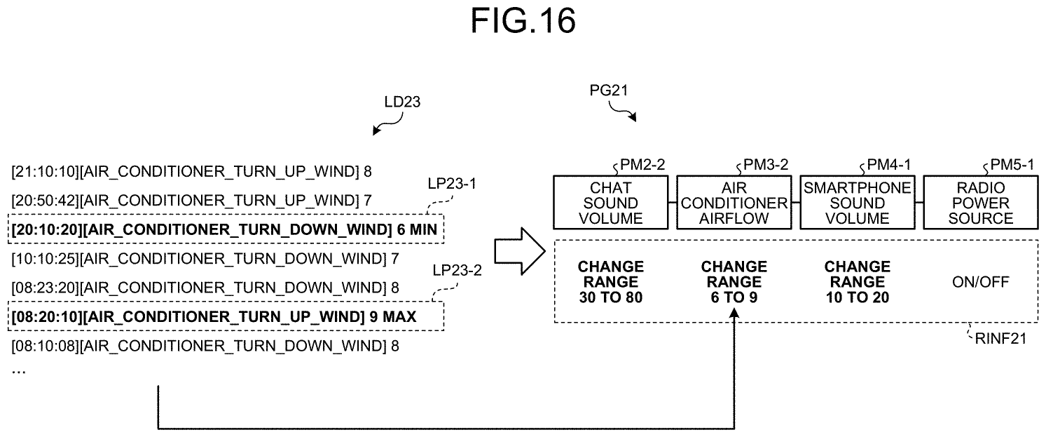

The following explanation is given about the operations illustrated in FIG. 16. FIG. 16 is a diagram illustrating another example of the operations performed using the operation history. More particularly, FIG. 16 is a diagram illustrating another example for deciding on the change ranges for the target parameters using the operation history.

As illustrated in FIG. 16, the information processing device 100 refers to the operation history and decides on the change ranges for the associated parameters. Thus, the information processing device 100 refers to the operation history and decides on the change ranges for the target parameters. The information processing device 100 refers to the past operation history such as log information LD23, identifies the region in which the parameters were changed in a certain period of time in the past, and performs parameter adjustment within that range.

More particularly, the information processing device 100 refers to the operation history such as the log information LD23, and decides on information RINF21 indicating the change ranges for the target parameters. Thus, the information processing device 100 refers to the information indicating the air conditioner airflow has the minimum value of “6” as indicated in a log portion PT23-1 and that the air conditioner airflow has the maximum value of “9” as indicated in a log portion LP23-2 in the log information LD23, and decides on the change range of “6 to 9” for the parameter PM3-2 corresponding to the air conditioner airflow. In an identical manner, the information processing device 100 decides on the change range of “30 to 80” for the parameter PM-2 corresponding to the chat sound volume, the change range of “10 to 20” for the parameter PM4-1 corresponding to the smartphone sound volume, and the change range of “ON/OFF” for the parameter PM5-1 corresponding to the radio power source.

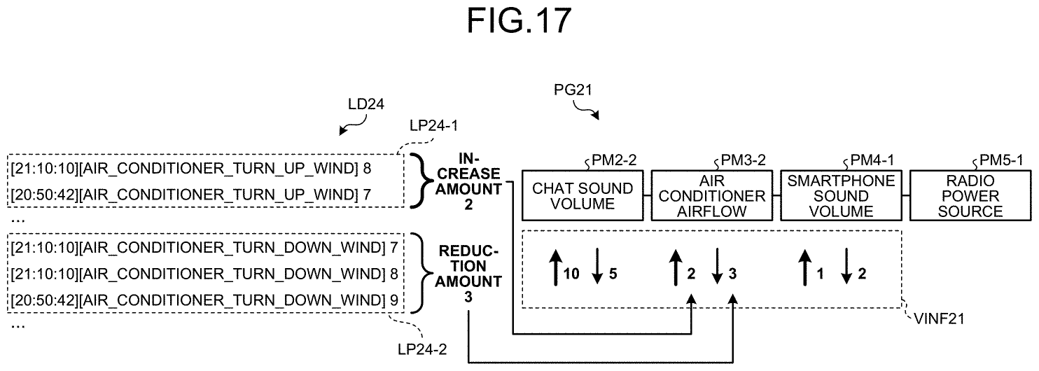

The following explanation is given about the operations illustrated in FIG. 17. FIG. 17 is a diagram illustrating another example of the operations performed using the operation history. More particularly, FIG. 17 is a diagram illustrating another example for deciding on the change amounts for the target parameters using the operation history.

As illustrated in FIG. 17, the information processing device 100 refers to the operation history and decides on the change amounts for the associated parameters. The information processing device 100 refers to the operation history and decides on the change amounts for the target parameters. The information processing device 100 refers to the past operation history (a log) such as log information LD24; identifies, from the past operation log, the change amounts (within a predetermined period of time) that were applied at the time of changing the parameters; and decides on the adjustment amounts for the associated parameters.

More particularly, the information processing device 100 refers to the operation history such as the log information LD24, and decides on information VINF21 regarding the change amounts for the target parameters. Thus, based on a series of operations illustrated in a log portion LP24-1 in the log information LD24, the information processing device 100 decides on an increase amount of “2” for the parameter PM3-2 corresponding to the air conditioner airflow. Moreover, based on a series of operations illustrated in a log portion LP24-2 in the log information LD24, the information processing device 100 decides on a reduction amount of “3” for the parameter PM3-2 corresponding to the air conditioner airflow. In an identical manner, based on a series of operations illustrated in the log portion LP24-1 in the log information LD24, the information processing device 100 decides on an increase amount of “10” and a reduction amount of “5” for the parameter PM2-2 corresponding to the chat sound volume. Moreover, based on a series of operations illustrated in the log portion LP24-1 in the log information LD24, the information processing device 100 decides on an increase amount of “1” and a reduction amount of “2” for the parameter PM4-1 corresponding to the smartphone sound volume. Meanwhile, since the change range for the parameter PM5-1 corresponding to the radio power source indicates either “ON” or “OFF”, the operation for deciding on the change amount is not performed.

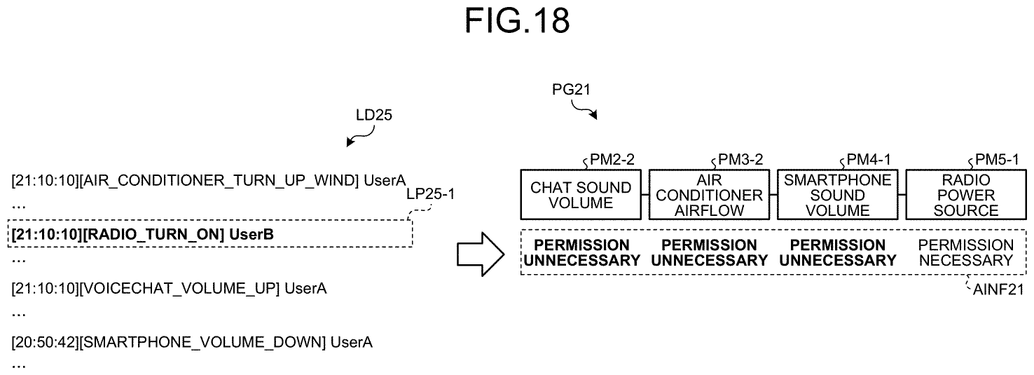

The following explanation is given about the operations illustrated in FIG. 18. FIG. 18 is a diagram illustrating another example of the operations performed using the operation history. More particularly, FIG. 18 is a diagram illustrating an example of the operations for deciding on whether to obtain permission for changing the target parameters using the operation history. With reference to FIG. 18, “UesrA” corresponds to the user U1 illustrated in FIG. 1, and “UesrB” corresponds to another user (such as a user U2) other than the user U1.

As illustrated in FIG. 18, the information processing device 100 refers to the operation history such as log information LD25 and, based on the associated users of the devices 10 having the target parameters, determines whether or not it is required to obtain permission for changing the parameters. The information processing device 100 refers to the operation history and identifies the associated users of the devices 10 having the target parameters. As illustrated in the log information LD25, since it is the user UesrA (the user U1) who changed the parameter PM2-2 corresponding to the chat sound volume, the information processing device 100 determines that there is no need to obtain permission for changing the parameter PM2-2. Moreover, as illustrated in the log information LD25, since it is the user UesrA (the user U1) who changed the parameter PM3-2 corresponding to the air conditioner airflow, the information processing device 100 determines that there is no need to obtain permission for changing the parameter PM1-1. Furthermore, as illustrated in the log information LD25, since it is the user UesrA (the user U1) who changed the parameter PM4-1 corresponding to the smartphone sound volume, the information processing device 100 determines that there is no need to obtain permission for changing the parameter PM1-1.

On the other hand, as illustrated in the log information LD25, since it is the user UesrB (the user U2) who changed the parameter PM5-1 corresponding to the radio power source, the information processing device 100 determines that permission is required for changing the parameter PM5-1. That is, since some other user (the user UesrB) other than the user UesrA (the user U1) turned ON the power source of a device E representing a radio, the information processing device 100 determines that permission of the UesrB (the user U2) is required for the operation of the parameter PM5-1 of the device E. In this way, when the command utterer who made an utterance including a request (i.e., the user U1) is different than the user of the device 10 having the concerned target parameter (i.e., the user U2), the information processing device 100 obtains permission of the user of that device 10 for adjusting (changing) the parameter of that device 10. In the example illustrated in FIG. 18, the information processing device 100 sends a notification such as “Is it ok to turn OFF the radio?” or “Is it ok to lower the sound volume?” to the user terminal of the user U2, and obtains permission from the user U2.

In this way, regarding the devices associated to different users, the information processing device 100 obtains permission of the respective users, so as to appropriately perform operations according to the utterances made by the users with respect to a plurality of devices, while holding down a decline in the user-friendliness of the other users.

[1-4-2. Regarding each Operation Phase]

Given below is the explanation about each operation phase. For example, whether each analysis phase is meant for performing analysis with respect to individual users can be set in advance by the developer. For example, the linking of the parameters, which undergo changes, can be decided at the time of product shipment. For example, the associated parameters can be decided at the time of product shipment.

Meanwhile, when the volume of the operation history of a user is not sufficient (is smaller than a predetermined reference value), such as in the case of a first-time user; the operations with respect to that user can be performed using the operation history of similar users having the similar age and gender or using the operation history of similar users having the similar environment or the similar behavior. Regarding a user who is present in an environment having a television, an air conditioner, and a radio; the information processing device 100 can use the average data of the users present in the same room environment (having a television, an air conditioner, and a radio). For example, when the operation history of a user who made an utterance (i.e., an uttering user) is not sufficient in volume, the target devices and the target parameters corresponding to the utterance of the uttering user can be decided using the operation history of that user, and the operations can be performed.

Moreover, as explained earlier, when the change range for a parameter as obtained from the operation history is exceeded, the information processing device 100 can change the action such as performing the operations after confirming them with the user. Thus, when the change range for a parameter is exceeded, the information processing device 100 confirms with user by asking “Is it ok to increase the level beyond the usual level?” and then performs the operation outside of the operation history range.

[1-4-3. Regarding Decision Method for Deciding on Associated Parameters]

For example, the information processing device 100 performs determinations according to the statistic obtained from the operation history of a user. However, when the associations cannot be clearly confirmed, the information processing device 100 can get a confirmation from the user so as to hold down erroneous operations. As a result, the information processing device 100 can hold down the situation in which unintended parameters are treated as associated parameters.

For example, regarding the parameters that are strongly associated as far as the operation history of the user is concerned, the information processing device 100 treats them as associated parameters without user confirmation. As explained earlier, regarding the parameters that are simultaneously operated with a probability equal to or greater than the first threshold value of “80%”, the information processing device 100 automatically treats those parameters as the associated parameters. Moreover, for example, in the operation history of the user, regarding the parameters that exhibit a not-so-strong association according to the numerical values, the information processing device 100 confirms them with the user and then treats them as the associated parameters. As explained earlier, regarding the parameters that are simultaneously operated with a probability equal to or greater than the second threshold value of “50%” and smaller than the first threshold value of “80%”, the information processing device 100 confirms with the user about those parameters and treats them as the associated parameters if the user gives permission.

For example, in the operation history, from among the 100 instances in which the chat sound volume was reduced, if the gaming sound volume was reduced in 90 instances, then the information processing device 100 considers that those parameters are simultaneously operated at a probability of 90% and thus automatically treats the chat sound volume and the gaming sound volume as the associated parameters. Moreover, for example, in the operation history, regarding the instances in which the chat sound volume was increased while some music was being played, if the music sound volume was reduced in 80% of those instances, then the information processing device 100 automatically treats the chat sound volume and the music sound volume as the associated parameters.

For example, in the operation history, regarding the instances in which the chat sound volume was increased while the air conditioner was in operation, if the air conditioner airflow was reduced in 60% of those instances, then the information processing device 100 confirms with the user about whether to treat the chat sound volume and the air conditioner airflow as the associated parameters.

For example, in the operation history, regarding the instances in which the chat sound volume was increased while the floor heating was turned ON, if the floor heating temperature was increased in 20% of those instances, then the information processing device determines that there is no association and does not treat the chat sound volume and the floor heating temperature as the associated parameters. Thus, the explanation given above is about the examples in which the threshold values are set in such a way that simultaneous operation with a probability equal to or greater than 80% results in immediate parameterization;

simultaneous operation with a probability equal to or greater than 50% and smaller than 80% results in confirmation with the user; and simultaneous operation with a probability smaller than 50% results in no parameterization. Accordingly, the threshold values can be set in an appropriate manner.

[1-4-4. Example of Operations Performed using Sensor Information]

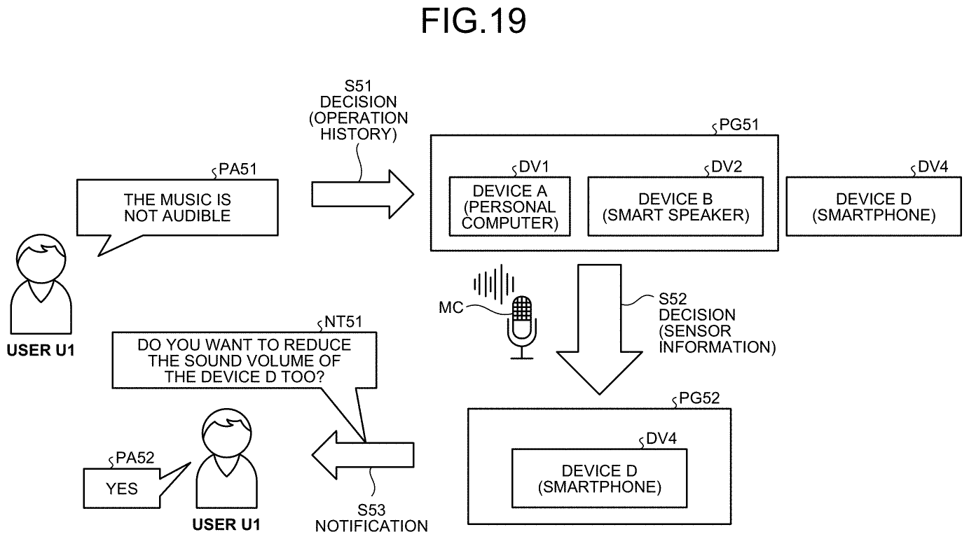

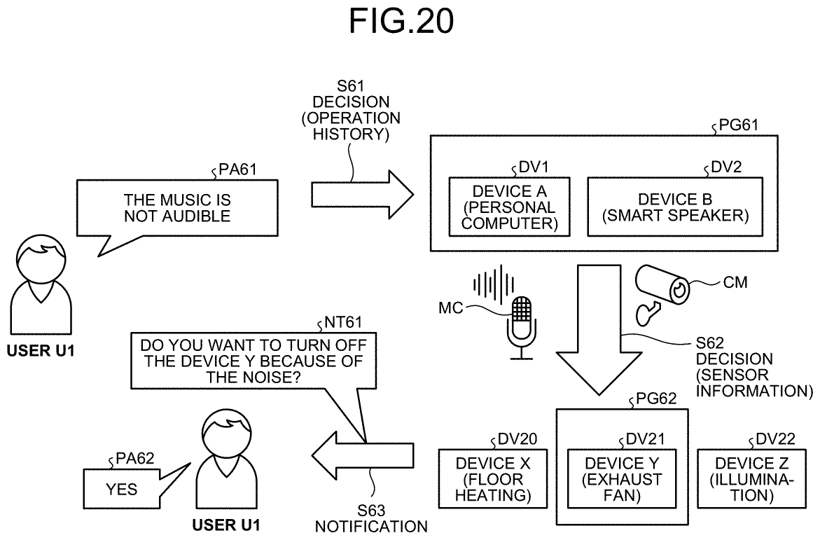

In the examples explained above, the operation history of the devices is used as an example of the device condition information indicating the condition of the devices. However, the device condition information is not limited to the operation history, and any other type of information can be used as long as it indicates the condition of the devices. For example, the information processing device 100 can use the sensor information, which is obtained by the sensors, as the device condition information. Regarding that point, the explanation is given below with reference to FIGS. 19 and 20. FIG. 19 is a diagram illustrating an example of the operations performed using the sensor information. FIG. 20 is a diagram illustrating another example of the operations performed using the sensor information.

As illustrated in FIGS. 19 and 20, the information processing device 100 can decide on the target devices using a variety of sensor information such as sound information and image information detected by various sensor devices 50 such as a microphone MC or a camera CM. In FIGS. 19 and 20 is illustrated an example of detection of the devices (the devices 10) that are not linked according to the operation history. In FIGS. 19 and 20 is illustrated an example of referring to the operation history and deciding on the target devices and the target parameters that should be simultaneously adjusted.

Firstly, explained below with reference to FIG. 19 is a case in which, regarding the devices 10 having similar types of parameters, the measurement is done about whether those devices 10 affect the user to a certain extent or more. With reference to FIG. 19, the user U1 makes utterances. For example, the user U1 makes an utterance PA51 saying “the music is not audible”.

Then, based on the utterance information corresponding to the utterance PA51 and based on the operation history, the information processing device 100 decides on the target devices (Step S51). In the example illustrated in FIG. 19, based on the associated-parameter information stored in the associated-parameter information storing unit 125 (refer to FIG. 8), the information processing device 100 decides on the parameter PM2-1 representing the music sound volume and the parameter PM1-1 representing the gaming sound volume as the target parameters. Then, the information processing device 100 decides on a device group PG51, which includes the device B having the parameter PM2-1 corresponding to the music sound volume and the device A having the parameter PM2-1, as the target devices. Thus, the information processing device 100 decides on the devices B and A as the target devices based on the operation history.

Moreover, based on the utterance information corresponding to the utterance PA51 and based on the sensor information detected by the microphone MC, the information processing device 100 decides on the target devices (Step S52). In the example illustrated in FIG. 19, the information processing device 100 identifies, from among the devices excluding the devices A and B, the devices having the power turned ON and having a sound-related parameter. Thus, from among a plurality of devices 10 stored in the device information storing unit 121 (refer to FIG. 4), the information processing device 100 identifies the device D that has the power turned ON and that has the parameter PM4-1 corresponding to the smartphone sound volume. That is, the information processing device 100 identifies, from among a plurality of devices 10, the device D that is a smartphone having the user U1 as the associated user. As a result, the information processing device 100 identifies the device D for which the association with the parameter PM2-1 is not detected in the operation history but which has a sound-related parameter.

Then, the information processing device 100 refers to the sensor information detected by the microphone MC and measures the extent of the effect of the sounds coming from the device D at the position of the user. In that case, the microphone MC can be a microphone installed in the device D that is a user terminal (smartphone) used by the user U1. For example, if the sound volume output by the device D as detected by the microphone MC is equal to or greater than the setting threshold value, then the information processing device 100 decides to treat the device D as the target device. On the other hand, if the sound volume output by the device D as detected by the microphone MC is smaller than the setting threshold value, then the information processing device 100 does not decide to treat the device D as the target device. In the case illustrated in FIG. 19, the information processing device 100 determines that the sound volume output by the device D is equal to or greater than the setting threshold value and thus decides to treat a device group PG52, which includes the device D, as the target device. In this way, if the user U1 is affected to a certain extent or more, the information processing device 100 asks the user about whether or not to adjust the sound volume of the concerned device 10 too.

Then, the information processing device 100 sends a notification to the user U1 to confirm whether or not operations are allowed with respect to the device D (Step S53). In the example illustrated in FIG. 19, the information processing device 100 sends notification information NT51 to the user U1 indicating “Do you want to reduce the sound volume of the device D too?”. For example, the information processing device 100 sends the notification information NT51 to the device D representing a user terminal (smartphone) used by the user U1, and makes the device D display or voice-output the notification information NT51.

Subsequently, if the user U1 gives permission to perform operations with respect to the device D, the information processing device 100 reduces the sound volume of the device D. In the example illustrated in FIG. 19, the information processing device 100 obtains utterance information of an utterance PA52 indicating “Yes” made by the user U1, and accordingly reduces the sound volume of the device D based on the obtained utterance information. Meanwhile, if the user U1 does not give permission to perform operations with respect to the device D, then the information processing device 100 excludes the device D from the target devices for parameter changing.

Explained below with reference to FIG. 20 is a case in which, regarding the devices 10 having similar types of parameters, the measurement is done about whether those devices 10 affect the user to a certain extent or more. With reference to FIG. 20, the user U1 makes utterances. For example, the user U1 makes an utterance PA61 saying “the music is not audible”.

Then, based on the utterance information corresponding to the utterance PA61 and based on the operation history, the information processing device 100 decides on the target devices (Step S61). In the example illustrated in FIG. 20, based on the associated-parameter information stored in the associated-parameter information storing unit 126 (refer to FIG. 8), the information processing device 100 decides on the parameter PM2-1 representing the music sound volume and the parameter PM1-1 representing the gaming sound volume as the target parameters. Then, the information processing device 100 decides on a device group PG61, which includes the device B having the parameter PM2-1 corresponding to the music sound volume and the device A having the parameter PM2-1, as the target devices. Thus, the information processing device 100 decides on the devices B and A as the target devices based on the operation history.

Moreover, based on the utterance information corresponding to the utterance PA61 and based on the sensor information detected by the microphone MC and the camera CM, the information processing device 100 decides on the target devices (Step S62). The information processing device 100 detects whether there is any device 10 that does not particularly have a sound volume parameter but that has a sound affecting the position of the user to a certain extent or more. In the example illustrated in FIG. 20, the information processing device 100 identifies, from among the devices 10 excluding the devices B and A, the devices 10 that are generating a sound around the user U1. Herein, the information processing device 100 implements various conventional sound-related technologies such as visualization of the sound field, and identifies the devices that are generating a sound around the user U1. The information processing device 100 refers to the sensor information detected by the microphone MC and the camera CM and refers to the position information of the devices 10 as stored in the device information storing unit 121 (see FIG. 4), and identifies the devices 10 that are generating a sound around the user U1.

In the example illustrated in FIG. 20, the information processing device 100 identifies the following devices 10 as the devices 10 present around the user U1: a device X representing floor heating and identified by a device ID “DV20”; a device Y representing an exhaust fan and identified by a device ID “DV21”; and a device Z representing illumination and identified by a device ID “DV22”. The information processing device 100 refers to the position information of the user U1 and the position information of the devices 10, and identifies the device 10 present within a predetermined range (for example, 5 m or 10 m) from the user U1. Then, from among the devices X, Y, and Z, the information processing device 100 identifies the device Y that is generating a sound. That is, the information processing device 100 identifies the device Y that represents an exhaust fan which does not have any sound-related parameter but which is generating a sound. As a result, although no association with the parameter PM2-1 is detected in the operation history, the information processing device 100 identifies the device Y that is affecting the position of the user U1 to a certain extent or more as far as the sound is concerned.

Then, the information processing device 100 refers to the sensor information detected by the microphone MC and measures the extent of the effect of the sound coming from the device Y at the position of the user. In that case, the microphone MC can be a microphone installed in a user terminal (smartphone) used by the user U1. For example, if the sound volume output by the device Y as detected by the microphone MC is equal to or greater than the setting threshold value, then the information processing device 100 decides to treat the device Y as the target device. On the other hand, if the sound volume output by the device Y as detected by the microphone MC is smaller than the setting threshold value, then the information processing device 100 does not decide to treat the device Y as the target device. In the case illustrated in FIG. 20, the information processing device 100 determines that the sound volume output by the device Y is equal to or greater than the setting threshold value and thus decides to treat a device group PG62, which includes the device Y, as the target device.

Then, the information processing device 100 sends a notification to the user U1 to confirm whether or not operations are allowed with respect to the device Y (Step S63). In the example illustrated in FIG. 20, the information processing device 100 sends notification information NT61 to the user U1 indicating “Do you want turn OFF the device Y because of the noise?”. For example, the information processing device 100 sends the notification information NT61 to the device Y representing a user terminal (smartphone) used by the user U1, and makes the device Y display or voice-output the notification information NT61. In this way, if the sound generated by the device Y, which represents a device (the device 10) not having a sound volume parameter, is affecting the user U1 to a certain extent or more, then the information processing device 100 proposes to turn OFF the device Y.

Subsequently, if the user U1 gives permission to perform operations with respect to the device Y, then the information processing device 100 turns OFF the power of the device Y. In the example illustrated in FIG. 20, the information processing device 100 obtains utterance information of an utterance PA62 indicating “Yes” made by the user U1, and turns OFF the device Y based on the obtained utterance information. Meanwhile, if the user U1 does not give permission to perform operations with respect to the device Y, then the information processing device 100 excludes the device Y from the target devices for parameter changing.

As explained above, as a result of using the sensor information, a device for which no relationship is found in the operation history but which generates a sound at a certain level or more as a sound source is detected by the sensor device 50, and the information processing device 100 asks the user about whether or not to treat that device as the target device for sound volume adjustment. For example, in the case of sound collection using a microphone, the information processing device 100 identifies the devices by checking which device affects the environment of that user (i.e., by checking the playback sequence of a plurality of devices). As a result, the information processing device 100 becomes able to treat an unexpected sound source, such as a defective exhaust fan that is generating a sound, as the target device for sound volume operations.

[1-4-5. Example of Operations Based on Relationship Among a Plurality of Users]

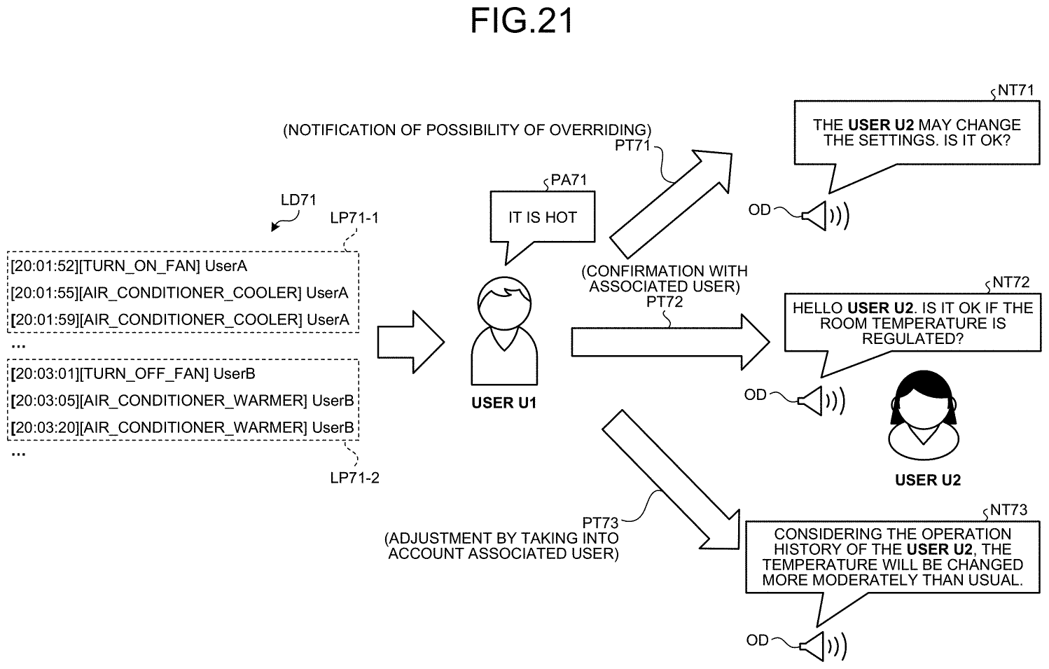

Explained below with reference to FIG. 21 is an example of the operations based on the relationship among a plurality of users. FIG. 21 is a diagram illustrating an example of the operations based on the relationship among a plurality of users.

In the example illustrated in FIG. 21, the information processing device 100 refers to the operation history in a log portion LP71-1, and decides on the operations according to the utterance of the user. In log information LD71, the log portion LP71-1 is included for indicating that the UserA (the user U1) turns ON the exhaust fan and turns on the cooling function of the air conditioner. Moreover, in the log information LD71, a log portion LP71-2 is included for indicating that, within a predetermined period of time (for example, two minutes or five minutes) since the operation performed by the UserA (the user U1), the UserB (the user U2) turns OFF the exhaust fan and turns ON the heating function of the air conditioner.

In the example illustrated in FIG. 21, it is assumed that, at the point of time at which the user U1 makes an utterance PA71, the user U2 is also present in the same space such as the same room as the user U1. Meanwhile, based on the sensor information detected by a sensor such as a camera, the information processing device 100 can identify that the users U1 and U2 are present in the same space. Since another user in the form of the user U2 is present along with the user U1, when the utterance information of the utterance PA71 indicating “it is hot” made by the user U1 is obtained, the information processing device 100 decides to perform operations by taking into account the fact that another user in the form of the user U2 is present along with the user U1.

For example, as illustrated in an operation pattern LP71, the information processing device 100 performs the operations of turning ON the exhaust fan and turning ON the cooling function of the air conditioner, and also issues a notification about the possibility of overriding. For example, the information processing device 100 makes an output device OD, such as a speaker, output notification information NT71 indicating “The user U2 may change the settings. Is it ok?”.

For example, as illustrated in an operation pattern LP72, before performing the operations of turning ON the exhaust fan and turning ON the cooling function of the air conditioner based on the utterance PA71 made by the user U1, the information processing device 100 confirms the situation with the associated users. For example, the information processing device 100 makes the output device OD, such as a speaker, output notification information NT72 indicating “Hello user U2. Is it ok if the room temperature is regulated?”. For example, the information processing device 100 can send the notification information NT72 to the user terminal used by the user U2, and make the user terminal display or voice-output the notification information NT72. If the user U2 gives permission, then the information processing device 100 performs the operations of turning ON the exhaust fan and turning ON the air conditioner.

For example, as illustrated in an operation pattern LP73, although the information processing device 100 performs the operations of turning ON the exhaust fan and turning ON the cooling function of the air conditioner based on the utterance PA71 made by the user U1, it also issues a notification indicating adjustment by taking into account the associated users. For example, the information processing device makes the output device OD, such as a speaker, output notification information NT73 indicating “Considering the operation history of the user U2, the temperature will be changed more moderately than usual”. Meanwhile, from among the operation patterns LP71 to LP73, the information processing device 100 either can decide on the operations based on predetermined criteria such as the power balance among the users or can decide the operations in a random manner. For example, if it is determined that the user U2 has greater authority to operate the devices 10 than the user U1, then the information processing device 100 decides to implement, from among the operation patterns LP71 to LP73, the operation pattern LP72 in which the situation is confirmed with the user U2 before performing the operation.

As explained above, as a result of performing the operations by taking into account the relationship among a plurality of users, the information processing device 100 becomes able to perform the operations at a higher level of user satisfaction.

[1-5. Sequence of Information Processing According to the Embodiment]

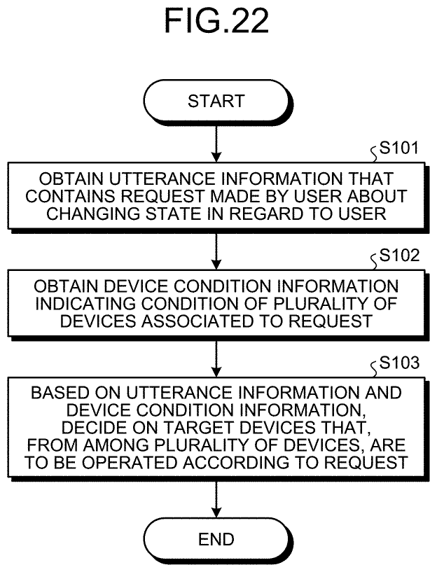

Explained below with reference to FIG. 22 is a sequence of a variety of information processing performed according to the embodiment. FIG. 22 is a flowchart for explaining a sequence of a variety of information processing performed according to the embodiment of the application concerned. More particularly, FIG. 22 is a flowchart for explaining the sequence of the decision operation performed by the information processing device 100.

As illustrated in FIG. 22, the information processing device 100 obtains utterance information that contains a request made by the user about changing the state in regard to the user (Step S101). For example, the information processing device 100 obtains the utterance information that contains a request such as “the music is not audible” about changing the state in regard to the user.

The information processing device 100 obtains the device condition information indicating the condition of a plurality of devices associated to the request (Step S102). For example, the information processing device 100 obtains the device condition information that contains the operation history related to a plurality of devices and contains sensor information detected by sensors at the point of time corresponding to the request.

Then, based on the utterance information and the device condition information, the information processing device 100 decides on the target devices that, from among a plurality of devices, are to be operated according to the request (Step S103). The information processing device 100 decides on the parameter that corresponds to the request based on the utterance information, decides to treat the associated parameters of that parameter as the target parameters, and decides to treat the devices having the target parameters as the target devices.

[2. Other configuration Examples]

In the example explained above, the device that decides on the target devices (i.e., the information processing device 100) is configured to be different than the device that detects the sensor information (i.e., the sensor device 50). However, those two devices can be integrated into a single device.

Of the processes described in the embodiments, all or part of the processes explained as being performed automatically can be performed manually. Similarly, all or part of the processes explained as being performed manually can be performed automatically by a known method. The processing procedures, the control procedures, specific names, various data, and information including parameters described in the embodiments or illustrated in the drawings can be changed as required unless otherwise specified. For example, a variety of information illustrated in the drawings is not limited to that information.

The constituent elements of the device illustrated in the drawings are merely conceptual, and need not be physically configured as illustrated. The constituent elements, as a whole or in part, can be separated or integrated either functionally or physically based on various types of loads or use conditions.

Meanwhile, the embodiment and the modification examples thereof can be appropriately combined without causing any contradictions in the contents of the operations.

Moreover, the effects written in the present written description are only exemplary, and it is possible to have other effects.

[3. Hardware Configuration]

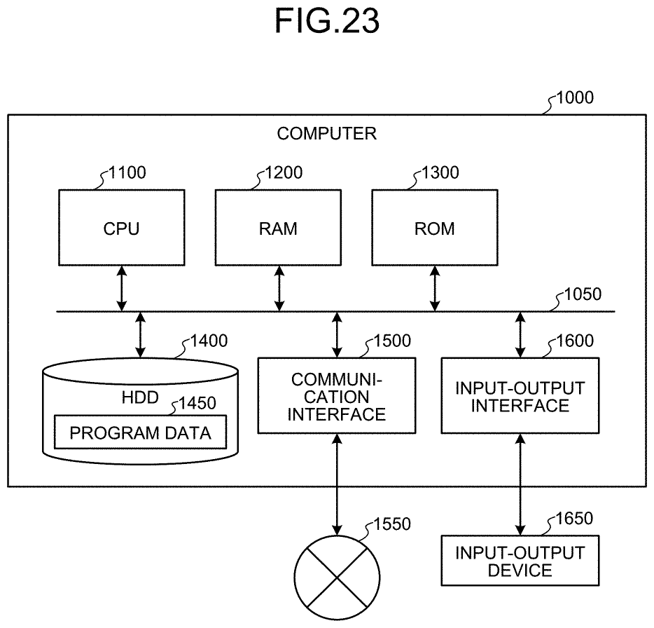

An information processing device such as the information processing device 100 according to the embodiment and the modification examples is implemented using, for example, a computer 1000 having a configuration illustrated in FIG. 23. FIG. 23 is a hardware configuration diagram illustrating an example of the computer 1000 that implements the functions of an information processing device such as the information processing device 100. The following explanation is given with reference to the information processing device 100 according to the embodiment. The computer 1000 includes a CPU 1100, a RAM 1200, a ROM (Read Only Memory) 1300, an HDD (Hard Disk Drive) 1400, a communication interface 1500, and an input-output interface 1600. The constituent elements of the computer 1000 are connected by a bus 1050.

The CPU 1100 performs operations based on programs stored in the ROM 1300 or the HDD 1400, and performs a variety of control. For example, the CPU 1100 loads the programs, which are stored in the ROM 1300 or the HDD 1400, into the RAM 1200, and performs operations corresponding to the various programs.

The ROM 1300 is used to store a boot program such as the BIOS (Basic Input Output System) that is executed by the CPU 1100 at the time of booting of the computer 1000, and to store hardware-dependent programs of the computer 1000.

The HDD 1400 is a computer-readable recording medium that is used to non-temporarily record programs executed by the CPU 1100 and the data used by those programs. More particularly, the HDD 1400 is a recording medium used to store an information processing program according to the application concerned, which represents an example of program data 1450.

The communication interface 1500 is an interface for connecting the computer 1000 to an external network 1550 (for example, the Internet). For example, the CPU 1100 receives data from other devices and sends generated data to other devices via the communication interface 1500.

The input-output interface 1600 is an interface for connecting an input-output device 1650 to the computer 1000. For example, the CPU 1100 receives data from an input device such as a keyboard or a mouse via the input-output interface 1600. Moreover, the CPU 1100 sends data to an output device such as a display, a speaker, or a printer via the input-output interface 1600. Furthermore, the input-output interface 1600 can function as a media interface that reads programs recorded in a predetermined recording medium (media). Examples of the media include an optical recording medium such as a DVD (Digital Versatile Disc) or a PD (Phase change rewritable Disk); a magneto-optical recording medium such as an MO (Magneto-Optical disk); a tape medium; a magnetic recording medium; and a semiconductor medium.

For example, when the computer 1000 functions as the information processing device 100 according to the embodiment, the CPU 1100 of the computer 1000 executes the information processing program that is loaded in the RAM 1200, and implements the functions of the control unit 130. The HDD 1400 is used to store the information processing program according to the application concerned and to store the data stored in the memory unit 120. Thus, the CPU 1100 reads the program data 1450 from the HDD 1400 and executes it. However, as another example, the CPU 1100 can obtain the programs from other devices via the external network 1550.

Meanwhile, a configuration as explained below also falls within the technical scope of the application concerned.
(1)

An information processing device comprising:

an obtaining unit that obtains
utterance information containing a request uttered by a user regarding changing state related to the user, and
device condition information indicating condition of a plurality of devices associated to the request; and

a deciding unit that, based on the utterance information and the device condition information obtained by the obtaining unit, decides on a target device that, from among the plurality of devices, is to be operated according to the request.
(2)

The information processing device according to (1), wherein the obtaining unit obtains the device condition information that contains operation history of the user with respect to the plurality of devices.
(3)

The information processing device according to (2), wherein the deciding unit decides on the target device based on the operation history in time slot that corresponds to point of time corresponding to the request.
(4)

The information processing device according to any one of (1) to (3), wherein the obtaining unit obtains the device condition information that contains sensor information detected by a sensor at point of time corresponding to the request. (5)

The information processing device according to any one of (1) to (4), wherein

the obtaining unit obtains
the utterance information containing a request about changing external environment corresponding to senses of the user, and
the device condition information of the plurality of devices corresponding to the external environment, and

the deciding unit decides on the target device that, from among the plurality of devices, is to be operated for changing the external environment.
(6)

The information processing device according to (5), wherein the obtaining unit obtains the utterance information containing a request about changing the external environment of a predetermined space in which the user is present.
(7)

The information processing device according to any one of (1) to (6), wherein, based on the utterance information and the device condition information, the deciding unit decides on a target parameter for change from among a plurality of parameters of the target device.
(8) The information processing device according to (7), wherein the deciding unit decides on whether to increase or reduce value of the target parameter.
(9)

The information processing device according to (7) or (8), wherein the deciding unit decides on change range for value of the target parameter.
(10) The information processing device according to any one of (7) to (9), wherein the deciding unit decides on change amount for value of the target parameter.
(11)

The information processing device according to any one of (1) to (10), wherein the obtaining unit obtains the utterance information containing identification information that enables identification of target to be changed according to request of the user.
(12)

The information processing device according to (11), wherein the obtaining unit obtains the utterance information containing the identification information that indicates specific device which outputs the target.
(13)

The information processing device according to (12), wherein the deciding unit decides to treat, as the target device, other device other than the specific device from among the plurality of devices.
(14)

The information processing device according to any one of (1) to (13), further comprising a notifying unit that, when the target device decided by the deciding unit has predetermined relationship with a plurality of users including the user, sends notification information regarding operation of the target device to other user other than the user from among the plurality of users.
(15)

The information processing device according to (14), wherein the notifying unit sends the notification information to the other user who uses the target device.
(16)

The information processing device according to (14) or (15), wherein the notifying unit sends the notification information to the other user who is affected by operation of the target device.
(17)

The information processing device according to any one of (14) to (16), wherein the notifying unit sends, to the other user, information for confirming whether or not it is possible to perform operation of the target device.
(18)

The information processing device according to (17), further comprising an executing unit that, when the other uses gives permission to perform operation of the target device, performs operation with respect to the target device.
(19)

The information processing device according to any one of (1) to (18), wherein

the obtaining unit obtains
the utterance information containing a request about changing state regarding sound, and
the device condition information indicating condition of the plurality of devices regarding the sound, and

the deciding unit decides on the target device that, from among the plurality of devices, is to be subjected to operation of output regarding the sound.
(20)

An information processing method comprising:

obtaining
utterance information containing a request uttered by a user regarding changing state related to the user, and
device condition information indicating condition of a plurality of devices associated to the request; and

deciding that, based on the obtained utterance information and the obtained device condition information, includes deciding on a target device that, from among the plurality of devices, is to be operated according to the request.

### REFERENCE SIGNS LIST

1 information processing system
100 information processing device
110 communicating unit
120 memory unit
121 device information storing unit
122 operation history information storing unit
123 sensor information storing unit
124 threshold value information storing unit
125 associated-parameter information storing unit
130 control unit
131 obtaining unit
132 analyzing unit
133 deciding unit
134 notifying unit
135 executing unit
136 sending unit
10-1, 10-2, 10-3 device
50 sensor device

1. An information processing device comprising:
an obtaining unit that obtains
utterance information containing a request uttered by a user regarding changing state related to the user, and
device condition information indicating condition of a plurality of devices associated to the request; and
a deciding unit that, based on the utterance information and the device condition information obtained by the obtaining unit, decides on a target device that, from among the plurality of devices, is to be operated according to the request.

2. The information processing device according to claim 1, wherein the obtaining unit obtains the device condition information that contains operation history of the user with respect to the plurality of devices.

3. The information processing device according to claim 2, wherein the deciding unit decides on the target device based on the operation history in time slot that corresponds to point of time corresponding to the request.

4. The information processing device according to claim 1, wherein the obtaining unit obtains the device condition information that contains sensor information detected by a sensor at point of time corresponding to the request.

5. The information processing device according to claim 1, wherein
the obtaining unit obtains
the utterance information containing a request about changing external environment corresponding to senses of the user, and
the device condition information of the plurality of devices corresponding to the external environment, and
the deciding unit decides on the target device that, from among the plurality of devices, is to be operated for changing the external environment.

6. The information processing device according to claim 5, wherein the obtaining unit obtains the utterance information containing a request about changing the external environment of a predetermined space in which the user is present.

7. The information processing device according to claim 1, wherein, based on the utterance information and the device condition information, the deciding unit decides on a target parameter for change from among a plurality of parameters of the target device.

8. The information processing device according to claim 7, wherein the deciding unit decides on whether to increase or reduce value of the target parameter.

9. The information processing device according to claim 7, wherein the deciding unit decides on change range for value of the target parameter.

10. The information processing device according to claim 7, wherein the deciding unit decides on change amount for value of the target parameter.

11. The information processing device according to claim 1, wherein the obtaining unit obtains the utterance information containing identification information that enables identification of target to be changed according to request of the user.

12. The information processing device according to claim 11, wherein the obtaining unit obtains the utterance information containing the identification information that indicates specific device which outputs the target.

13. The information processing device according to claim 12, wherein the deciding unit decides to treat, as the target device, other device other than the specific device from among the plurality of devices.

14. The information processing device according to claim 1, further comprising a notifying unit that, when the target device decided by the deciding unit has predetermined relationship with a plurality of users including the user, sends notification information regarding operation of the target device to other user other than the user from among the plurality of users.

15. The information processing device according to claim 14, wherein the notifying unit sends the notification information to the other user who uses the target device.

16. The information processing device according to claim 14, wherein the notifying unit sends the notification information to the other user who is affected by operation of the target device.

17. The information processing device according to claim 14, wherein the notifying unit sends, to the other user, information for confirming whether or not it is possible to perform operation of the target device.

18. The information processing device according to claim 17, further comprising an executing unit that, when the other uses gives permission to perform operation of the target device, performs operation with respect to the target device.

19. The information processing device according to claim 1, wherein
the obtaining unit obtains
the utterance information containing a request about changing state regarding sound, and
the device condition information indicating condition of the plurality of devices regarding the sound, and
the deciding unit decides on the target device that, from among the plurality of devices, is to be subjected to operation of output regarding the sound.

20. An information processing method comprising:
obtaining
utterance information containing a request uttered by a user regarding changing state related to the user, and
device condition information indicating condition of a plurality of devices associated to the request; and
deciding that, based on the obtained utterance information and the obtained device condition information, includes deciding on a target device that, from among the plurality of devices, is to be operated according to the request.
